(19) United States
(12) Patent Application Publication
(10) Pub. No.: US 2018/0207863 A1
(43) Pub. Date: Jul. 26, 2018

(54) METHODS AND APPARATUS FOR ADDITIVE MANUFACTURING USING EXTRUSION AND CURING AND SPATIALLY-MODULATED MULTIPLE MATERIALS

(71) Applicant: Southern Methodist University, Dallas, TX (US)

(72) Inventors: Daniel Porter, Dallas, TX (US); Adam Cohen, Dallas, TX (US); Paul Samuel Krueger, Plano, TX (US); David Son, Dallas, TX (US)

(21) Appl. No.: 15/876,945

(22) Filed: Jan. 22, 2018

Related U.S. Application Data
(60) Provisional application No. 62/448,833, filed on Jan. 20, 2017.

(51) Int. Cl. B29C 64/129; B29C 64/241; B29C 64/40; B29C 64/264; B29C 64/209; B29K 83/00

(52) U.S. Cl. CPC B29C 64/129; B29C 64/241; B29K 2083/00; B29C 64/264; B29C 64/209; B29C 64/40

(57) ABSTRACT

Methods and apparatus for additive manufacturing using extrusion and curing, and for multi-material spatially-modulated extrusion-based additive manufacturing are described, in which material composition and/or color can be varied locally to create abrupt transitions or controlled gradients, and in which objects may be fabricated from thermoset materials.

### CROSS REFERENCE TO RELATED APPLICATIONS

This application claims benefit of priority from U.S. Provisional Patent Application No. 62/448,833 filed Jan. 20, 2017, which is incorporated herein by reference.

### STATEMENT OF FEDERALLY FUNDED RESEARCH

Not applicable.

### TECHNICAL FIELD

This disclosure relates generally to the fields of additive manufacturing (AM), commonly known as 3-D printing, and more particularly to the field of extrusion-based additive manufacturing processes.

### BACKGROUND

Without limiting the scope of the disclosure, its background is described in connection with 3-D printing/additive manufacturing.

AM has had many achievements over the years and is currently a $5.1B industry. However, it has yet to achieve some of its ultimate potential. An area in which development has been limited is the production of objects from materials that are deposited in liquid, paste, or gel form, and which require the addition of energy to solidify—such as thermosets—and multi-material objects. Several attempts have been made to incorporate multiple materials in a single structure using an AM system, and three companies—Objet Geometries (now Stratasys), 3D Systems, and ARBURG—have or will soon have commercial products. As important as these activities have been to promoting the state of the art in multi-material AM, they remain lacking. In particular, the ability to incorporate multiple materials at arbitrary locations in a fabricated object, with abrupt, discontinuous transitions between materials, so that composition and properties can be precisely spatially modulated on a voxel (volume element)-by-voxel basis, is very limited, as is the ability to form objects with controlled compositional gradients.

In Objet's PolyJet process (similar to 3D Systems' MultiJet Printing), photopolymer resins are inkjet printed and immediately polymerized upon deposition. Fabrication of prototypes with grayscale appearance may be obtained by jetting two different materials (e.g., black, white, translucent) in various ratios in the same location, with mixing occurring on the surface of the previous layer. By jetting materials with different hardnesses (e.g., rigid and elastomeric) onto the previous layer, a degree of intermixing occurs and a range of durometers can be obtained. However, the PolyJet process is intrinsically limited to photopolymers, which can be costly and whose properties (e.g., impact resistance, biocompatibility, strength, stability, and/or tear resistance) are unsuitable for some applications. Moreover, the photopolymers used must be capable of being inkjet printed (e.g., low viscosity, proper surface tension) and prototypes require significant post-processing to remove support material. Despite the excellent resolution and speed of PolyJet, the high cost of multi-material machines is prohibitive vs. simpler, single-material AM equipment. ARBURG's plastic “freeforming” system deposits thermoplastic droplets and seems to accommodate just two materials at a time, with no ability to mix the two. The initial cost of this machine was set at 120,000-150,000 euros.

Multi-color AM (in which color varies but material is essentially the same throughout) has been achieved commercially by Z Corporation (now 3D Systems) using inkjet printing of colored binder into white powder, by PolyJet, using differently-colored photopolymers, and by MCor using inkjet printing of paper. With respect to the first of these, even once infiltrated with such materials as reinforcing adhesives (e.g., cyanoacrylates) colors tend to be unsaturated. Meanwhile, Polyjet materials and equipment are very costly and material properties are lacking; MCor's process produces paper parts which are intrinsically quite weak.

Material extrusion AM—first commercialized by Stratasys Inc. in the form of Fused Deposition Modeling (FDM)—may be extended to provide a beneficial multi-material AM process. In FDM, a thermoplastic polymer filament is melted and extruded from the orifice of a nozzle (FIG. 1). The printhead moves in an X/Y path, laying down complexly-shaped extrudates that define the cross-section of each layer. In some implementations, a second material is extruded through a separate nozzle to fabricate soluble support structures as part of the building process.

Though rather low in throughput due to the serial nature of the process, material extrusion AM has in general several key benefits: 1) very low cost due to intrinsic simplicity (some machines now sell for less than $300); 2) fabrication using robust engineering thermoplastic polymers such as ABS (Acrylonitrile Butadiene Styrene); 3) the ability to monolithically fabricate complex, multiple-component assemblies of moving parts; and 4) suitability for an office environment (i.e., safe process and materials).

Material extrusion AM lends itself well to an AM process in which multiple materials can be dispensed and mixed, including composite materials with particulates that expand the range of achievable physical properties. Moreover, material extrusion AM is ideal for processing polymers. Polymers are very promising candidates for fabricating multiple-material functional devices as they offer a very wide range of properties, are low-cost, can have good strength-to-weight ratios, are corrosion-resistant, and are easily processed and incorporated into composites, including conductive and magnetic composites. Metals, by comparison, tend to be heavy, costly, harder to process, and often prone to corrosion. Lastly, ceramics—used in few AM processes—tend to be brittle, costly, and hard to process.

Others have considered the use of FDM to create multi-material structures. A Stratasys patent [Skubic et al., 2011] on a viscosity pump for material extrusion AM parenthetically describes the use of multiple polymer liquefiers plumbed to a single feed screw-type extruder, and notes (though doesn't claim) the potential for multi-material models. However, the system described seems incapable of rapidly (e.g., over a distance of 1 mm or less) switching between materials on the fly, especially without cross-contamination and uncontrolled gradients as would be needed for a practical system. If commercialized, its use would probably be limited to creating structures from a single blended material, or those with gradually-varying composition or color. A U.S. patent application [Oxman, 2011, #1] and publication [Oxman, 2011, #2] describe melting, mixing, and extruding multiple materials to achieve functionally graded structures. Like the Skubic application, the proposed system doesn't address the often-essential need to rapidly, abruptly, and cleanly switch materials as needed. A MakerBot U.S. patent application [Pax, 2014] discusses transitioning between materials by withdrawing one material from the printhead along its normal entry path (i.e., by reversing the filament) and replacing it with another material, but doesn't ensure there is minimal inter-contamination between materials. Indeed, it correctly assumes that materials will not remain separated and will mix, and further describes moving a “transition region” (i.e., mixed material) out of the printhead. However, it seems to make no provision for (albeit wastefully) disposing of the mixed material and not re-introducing it into the printhead. Another MakerBot U.S. patent application [Boyer et al., 2014] discusses methods of moving transitions/mixed material regions away from object surfaces so as to hide/bury them on the interior of the object. While this may be acceptable for transitions involving a change in appearance (e.g., color), it is often not acceptable for those involving changes in material properties, as the particular functionality different materials provide is usually not confined to visible surfaces. Neither MakerBot application provides any specific approach for rapid mixing of viscous materials to achieve blended properties.

It might be assumed that multi-material structures could be produced by simply extending the conventional FDM process to multiple nozzles, and some FDM-based machines include two or three nozzles, each fed by a different filament. However, such approaches do not provide inter-mixing between materials and are thus limited to just a few materials, nor can they tightly control gradation for functionally graded structures. One AM system, from botObjects Ltd., uses five filaments—each of a different color—fed into a common printhead, and extrudes from a nozzle a gradually-changing mixture of colors. However, no provision is made to avoid cross-contamination and achieve rapid transitions. Moreover, only color variation is provided, not modulation of useful material properties such as hardness or stiffness. An experimental system for online mixing and extrusion of inks has recently been described [Ober et al., 2015]; it is however not capable of rapid transitions.

Thermosets and elastomers. The use of thermoset materials in AM has been minimal, despite several established benefits and wide industry use in general. The exception is the relatively inferior class of photocurable thermosets used in stereolithography and the PolyJet process such as acrylates and epoxies. Also noteworthy is the relative paucity and poor properties of elastomeric materials in AM, despite their widespread utility in products ranging from medical devices, to gaskets, to cookware, to molds. Elastomeric materials are commercially available so far in the PolyJet, selective laser sintering, and MultiJet Printing AM processes, but the range of properties is limited and strength of the materials is poor. For example, according to material data sheets, PolyJet elastomers with durometers of 26-28 and 40 Shore A have tensile strengths 4-6 times lower, and tear strengths 6-9 times lower, than NuSil liquid silicone elastomers (i.e., polysiloxane) of similar durometers, therefore greatly limiting their usefulness. Moreover, elongation to break of PolyJet elastomers is significantly lower (e.g., 20-45% of that typically available with silicone elastomers). Comparing SLS and silicone elastomers of similar durometer, a similar large discrepancy in properties such as tear strength and elongation is noted: approximately 4-5 times worse for SLS, though this discrepancy can be reduced somewhat by infiltrating the porous SLS object with a suitable liquid. Recently, elastomer filaments for FDM have been marketed; however, they are relatively hard (e.g., 75 shore A durometer or higher).

Overall, thermally-cured silicone elastomers have excellent properties such as chemical resistance, flexibility, wide service temperature range, and moisture and ultraviolet light resistance, and excellent medically-relevant properties such as long-term implantability, sterilizability, and gas and drug permeability. Some [Periard et al., 2007] have experimented with extruding RTV (room temperature vulcanizing) silicones from a nozzle, but the resulting structures are poorly-defined and the materials lack biocompatibility. Others, such as Hyrel L.L.C. (Norcross, Ga.) are experimenting with ultraviolet light-cured silicone and recently introduced cold and warm extrusion heads with provision for photoinitiated crosslinking. However, materials containing photoinitiators typically have limited biocompatibility.

Recently, Fripp Design (United Kingdom) and the University of Sheffield have developed a process using MIT's “3D Printing” inkjet-deposited binder and powder process to create soft tissue prosthetics by fabricating delicate starch-based preforms, infiltrating them with silicone, and curing. Such composites would not however, be implantable, and as conceded by Fripp, their durability and mechanical properties are limited. Moreover, the material properties such as hardness cannot be spatially-modulated with this approach. Using more biocompatible, thermally-cured silicones in a stereolithography-like process, with localized heating provided by an IR laser, or using light (e.g., UV)-cured silicones with a light source (e.g., laser, LED, metal halide bulb with light guide, along with any associated optics such as lenses, beam shapers, and baffles) to cure them, would (if attempted) waste unused material in the vat (which would eventually solidify), leaves a residue of uncured silicones, and does not allow spatially-modulated composition. More recently, Fripp has developed a process (International application number PCT1GB2014/053190) for silicone AM in which a needle deposits one part of a two-part silicone into a bath of the second part, with the two liquids reacting and curing. This process has several limitations, however, including: the inserted nozzle and deposited liquid may disturb already-cured regions of the object and create nonuniformities in layer thickness; inadequate mixing of the two materials; applicability only to certain types of silicones; a limited range over which properties can be spatially modulated since only one of two components can be varied; poor feature definition due to diffusion; incomplete curing resulting in tacky surfaces or interior volumes; the need to wash, rinse, and dry objects before use; difficulty removing uncured silicone from long, narrow channels or large internal volumes through small holes; and imperfectly-established neutral buoyancy and fixation of the object during fabrication, leading to layer misalignment and other distortions (so that supports cannot entirely be eliminated as claimed).

A recent paper [Hardin et al., 2015] describes a microfluidic printhead for dispensing two polydimethylsiloxane-based inks through a single nozzle. This printhead provides for no mixing or intentional grading of materials, while transitions between materials which are ideally abrupt are in fact somewhat graded, especially at low flow rates. Moreover, transitions at high flow rates can be challenging because one has to start and stop the flow quickly.

Recently, several companies have appeared on the scene offering 3-D printing of silicone materials using inkjet dispensing (e.g., ACEO (Wacker Chemie AG, Burghausen, Germany) or extrusion (e.g., Sterne Elastomere (Cavaillon, France)). These approaches, however, are not able to produce multiple material structures with graded properties or abrupt transitions.

### SUMMARY

The disclosure describes multiple-material AM methods and apparatus for point-of-use metering, micro-mixing, and extrusion of multiple materials, with the ability to abruptly transition between materials as well as create functionally graded properties through continuous variation of properties. Using these methods and apparatus, material composition and properties can be modulated locally and arbitrarily throughout the volume of a heterogeneous and/or anisotropic fabricated object according to a digital design. The disclosure further describes methods and apparatus for AM involving thermal curing of thermoset materials such as silicones, allowing high-quality elastomer objects (e.g., substantially homogeneous or heterogeneous) to be produced. It further comprises methods and apparatus for AM involving thiol-ene materials. Other novel aspects described in the disclosure include: precision micro-blending and extrusion methods and apparatus providing microscale, rapid inter-mixing of liquids including high-viscosity materials; methods, apparatus, and processing and control methodologies comprising purging and extrusion/deposition to enable rapid transitions with minimal cross-contamination; strategies for curing; support materials; mitigation of potential printing issues; high-pressure printing apparatus, and a variety of applications. In some embodiments, objects are additively manufactured at least in part from thermoplastic materials such as ABS, nylon, and polylactic acid as the feedstock, while in other embodiments, objects are additively manufactured at least in part from thermoset materials such as silicone rubber, epoxy, polyimide, polyester, vinylester, phenolic, polyurethane, or various rubbers (the last of which may require vulcanization to achieve the desired properties).

The disclosure describes methods and apparatus for deposition of multiple, dissimilar materials with high spatial resolution (e.g., 50-300 μm) in material composition, sharp boundaries between different material volumes, and controlled cross-contamination. By offering precision control over material composition, the design space for objects made with AM is greatly increased. In the case of thermoplastic materials, multiple thermoplastic materials (e.g., in the form of a filament) are controllably fed into a printhead having a point-of-use microfluidic mixing chamber (MMC). In the case of non-thermoplastic (e.g., thermoset) materials, multiple thermoset components in a flowable form (e.g., liquid) are controllably metered into a printhead having a point-of-use microfluidic mixing chamber. In either case, the materials are blended homogeneously in the chamber in the desired proportions and extruded, whereupon they solidify (through cooling if thermoplastic, or through rapid thermal curing or other means if thermoset) to form a portion of a layer. The printhead can blend multiple compatible materials having different properties (e.g., modulus of elasticity), producing composites with properties determined by the source materials and their mixing ratio(s).

The printhead can operate continuously, producing long extrudates (FIG. 2, left) or short and “micro” extrudates (FIG. 2, right) of pure material or of mixed material, the latter with a blend ratio which can be held constant or vary gradually and continuously. In FIG. 2, the various materials are depicted in various colors; these can indicate actual variations in visual appearance (e.g., colors, different gray levels) of a single material and/or indicate different materials. In the case of long and short extrudates, materials are mixed and extruded simultaneously and continuously; this is similar to conventional FDM but with point-of-use mixing of multiple materials. When an abrupt transition in color or material is required, the printhead can operate in an alternative mode, in which material in the MMC is substantially completely purged before new material is introduced, to minimize cross-contamination. While it is possible to purge such material into a waste container, for example, it is also possible with proper design of the printhead to avoid wasteful purging and build with all or most of the material in the MMC before the transition. If required, abrupt transitions can follow one another in rapid succession with the printhead operating in a pulsed, purging mode, in which it dynamically deposits extrudates such as micro extrudates (FIG. 2, right). A micro extrudate can have approximately the volume of the MMC (e.g., tens to hundreds of nanoliters) and be composed of pure or mixed material. In this mode, material can be thoroughly blended if needed during one portion of a cycle, and extruded during another portion; a cycle can be completed in a short time (e.g., milliseconds or tens of milliseconds). Long, short, and micro extrudates can be deposited in arbitrary order along a toolpath.

It is an object of some embodiments of the subject matter described here to provide a multi-material extrusion-based additive manufacturing process and apparatus which can fabricate objects comprising multiple materials.

It is an object of some embodiments of the subject matter described here to provide a multi-material extrusion-based additive manufacturing process and apparatus which can fabricate objects with multiple shades of gray or multiple colors.

It is an object of some embodiments of the subject matter described here to provide a multi-material extrusion-based additive manufacturing process and apparatus which can fabricate objects from at least one functionally graded material.

It is an object of some embodiments of the subject matter described here to provide a multi-material extrusion-based additive manufacturing process and apparatus wherein the transition between one material or property and an adjacent material or property, along the axis of a single extrudate, can be abrupt and discontinuous, with minimal waste of material.

It is an object of some embodiments of the subject matter described here to provide a multi-material extrusion-based additive manufacturing process and apparatus wherein the transition between one material or property and an adjacent material or property, along the axis of a single extrudate, can be gradual and continuous.

It is an object of some embodiments of the subject matter described here to provide an extrusion-based additive manufacturing process and apparatus which can fabricate objects from thermoset materials.

It is an object of some embodiments of the subject matter described here to provide a multi-material extrusion-based additive manufacturing process and apparatus which can fabricate structures from well-mixed materials.

It is an object of some embodiments of the subject matter described here to provide an extrusion-based additive manufacturing process and apparatus which can fabricate objects from thiol-ene materials.

It is an object of some embodiments of the subject matter described here to provide an extrusion-based additive manufacturing process and apparatus which can fabricate drug-delivery implants.

Other objects and advantages of various embodiments of the subject matter described here will be apparent to those of skill in the art upon review of the teachings herein. The various embodiments of the subject matter described here, set forth explicitly herein or otherwise ascertained from the teachings herein, may address one or more of the above objects alone or in combination, or alternatively may address some other object ascertained from the teachings herein. It is not necessarily intended that all objects be addressed by any single aspect of the subject matter described here even though that may be the case with regard to some aspects. Other aspects of the subject matter described here may involve combinations of the above noted aspects of the subject matter described here. These other aspects of the subject matter described here may provide various combinations of the aspects presented above as well as provide other configurations, structures, functional relationships, and processes that have not been specifically set forth above.

### BRIEF DESCRIPTION OF THE DRAWINGS

FIG. 1 is a 3-D view of a system for fused deposition modeling (prior art).

FIG. 2 is a 3-D view of extrudates of different lengths.

FIG. 3 is a 3-D view of a deposition head.

FIG. 4 is a cross-sectional 3-D view of a deposition head using thermoplastic filaments.

FIG. 5 is schematic front view of apparatus used in some embodiments.

FIG. 6 is a cross-sectional 3-D view of a deposition head for thermoset materials.

FIG. 7(a-k″) depicts cross-sectional elevation views of phases in a multi-material deposition process.

FIGS. 8(a-c) depicts the chemical structure of thiol-ene components.

FIGS. 9(a-c) depicts 3-D views of a microfluidic mixing chamber and a diagraph showing possible streamlines.

FIGS. 10(a-b) depicts in cross-sectional elevation view a printhead with a plunger tip and microfluidic mixing chamber which are hemispherical.

FIGS. 11(a-b) depicts in cross-sectional elevation view a rotating nozzle mixing extrudate.

FIGS. 12(a-d) depicts in cross-sectional elevation views of several approaches to heating a thermoset material.

FIG. 13(a-b) depicts in cross-sectional elevation views of a printhead for cooking and curing materials.

FIGS. 14(a-b) and FIGS. 15(a-e) depict methods of building with support material.

FIGS. 16(a-b) shows a method of building non-solid structures.

FIGS. 17(a-d) depicts a high pressure ram system.

FIG. 18 depicts a portion of a high pressure fluid system.

FIGS. 19(a-c) shows a printhead comprising curing apparatus.

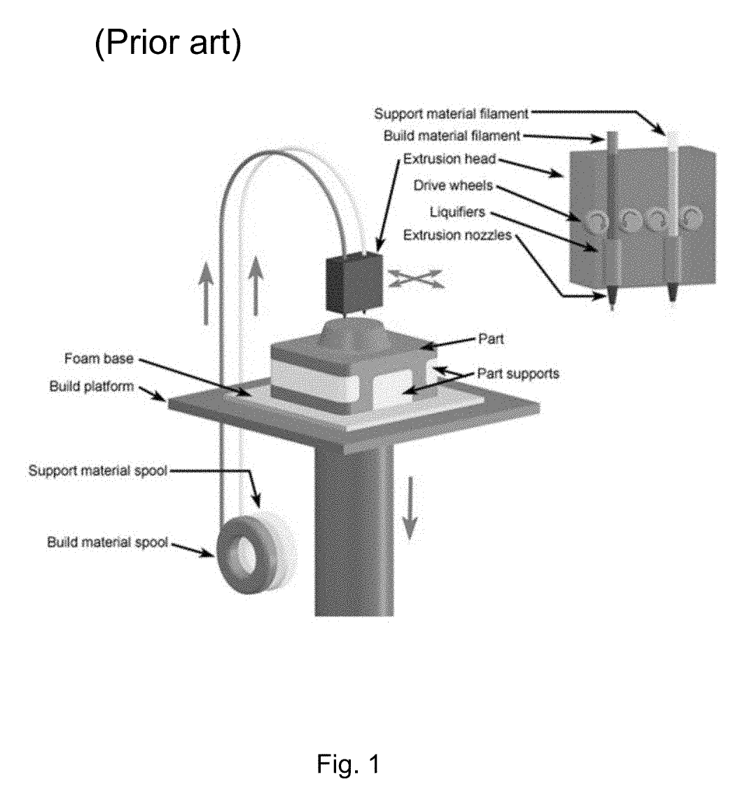

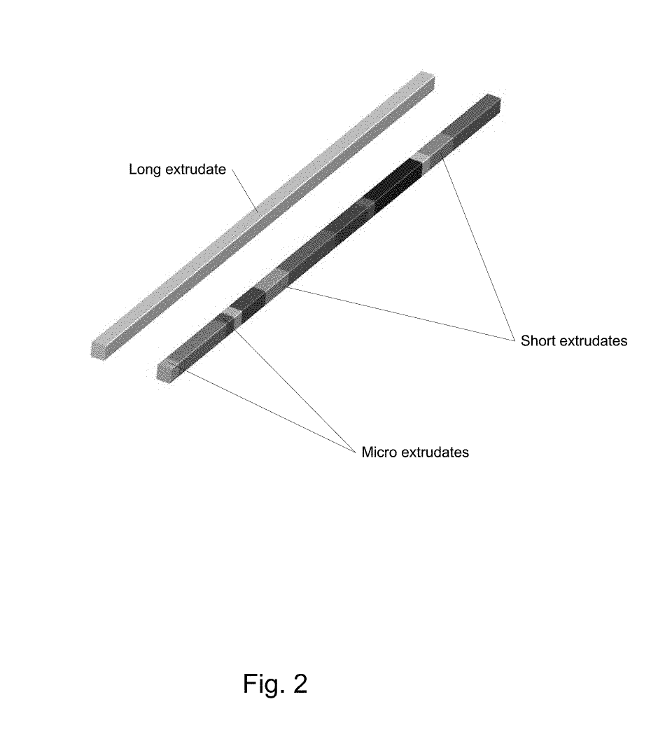

Like reference symbols in the various drawings indicate like elements.

### DETAILED DESCRIPTION OF THE EMBODIMENTS

Apparatus

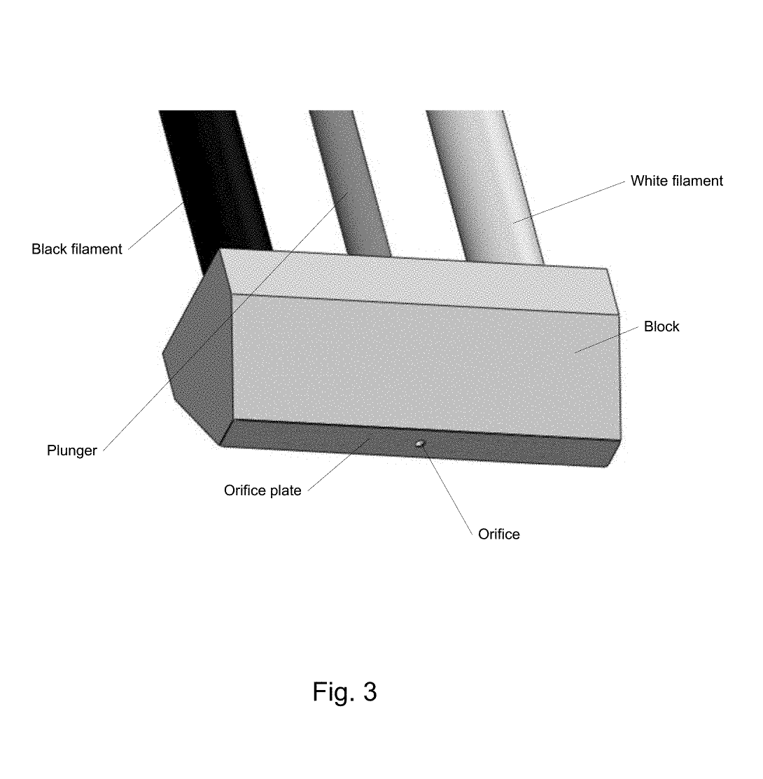

FIG. 3 is an exterior 3-D view of a printhead used in some embodiments for deposition of multiple thermoplastic materials. As shown, two thermoplastic materials are provided in filament form. For clarity, one is shown as white and one as black; however, these do not necessarily represent specific colors, and if they do, it not to the exclusion of other colors which may be used. The materials may also be clear, or the materials may have the same color, but different properties (e.g., different hardness or elastic modulus), etc. In some embodiments, more than two filaments may be provided. Also shown in the figure are a plunger and an orifice plate having an orifice. In some embodiments the orifice plate may not be flat externally as depicted, but may have an externally-conical shape typical of FDM printhead nozzles, or another shape. In lieu of a plunger, another means of provide displacement, such as a diaphragm, bellows, or screw may be used in some embodiments.

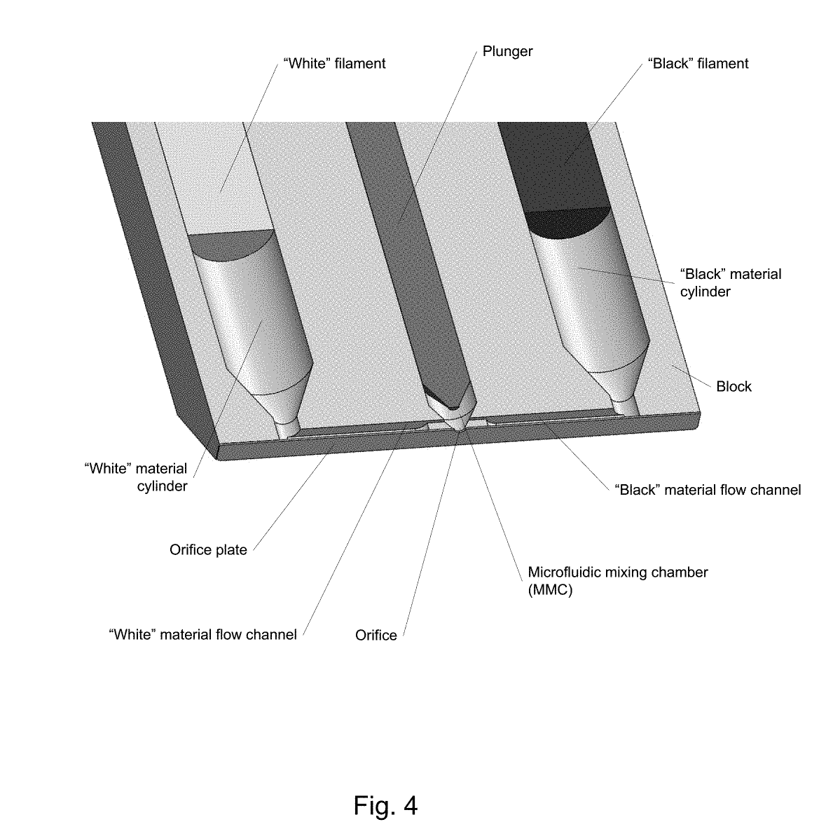

FIG. 4 shows a cross-sectional 3-D view of the printhead of FIG. 3. The head comprises a block which may be machined from aluminum or other material. Filaments are precisely fed into cylinders within the block, e.g., by rollers, drive wheels, or gears (not shown). At least the lower portion of the block is heated to a desired temperature to melt the thermoplastic using cartridge heaters (not shown) or other means, e.g., using a closed loop temperature control system using a thermistor, thermocouple, or other sensor for feedback. In some embodiments, the block comprises thermal isolating elements between the two cylinders and separate heaters, individually controlled in temperature, such that different materials may be melted at different temperatures.

Upon heating, molten material fills each cylinder. Advancing the unmelted filaments, which serve as pistons, forces molten materials into the “white” and “black” material flow channels, and from there to an MMC provided within the block. As shown, the MMC is conical, but may be hemispherical, cylindrical (with a flat end), or have other shapes. At the bottom of the MMC is an orifice plate (e.g., thin electroformed nickel) with an orifice; in some embodiments, the orifice may be provided as part of the block. In some embodiments, other methods of extruding thermoplastic materials, supplied either as filaments or in other forms, may be used, for example, screw extruders, gear pumps, and heated syringe pumps.

Also located within the MMC is a plunger, which can rotate around its longitudinal axis as well as translate along this axis (e.g., driven by a voice coil actuator). In some embodiments the lower end is terminated by a disk-shaped nub which can enter the orifice if it is of cylindrical geometry; in other embodiments, the orifice is conical or hemispherical in shape and the lower end of the plunger can enter it substantially without a nub. The plunger has several potential functions: 1) providing a top to the MMC and optionally varying MMC volume by its position; 2) rotating to help intermix the materials as will be described below; 3) purging the MMC (by descending fully, e.g., with the nub on the plunger extended through the orifice); 4) cutting off material flow into the MMC (by descending); and optionally, 5) stopping flow from the orifice before the printhead makes large jumps, minimizing the risk of “stringers” (thin strands of polymer, which can be located so as to distort the fabricated object's intended shape or surface finish). In some embodiments the plunger comprises a conical (as shown) or hemispherical lower end. The plunger can rotate, if required, at high speeds (e.g., 100,000 RPM), e.g., driven by a high-speed electric or pneumatic motor, providing mixing of relatively high-viscosity materials such as molten ABS (Acrylonitrile butadiene styrene) at low Re (Reynolds number) in the small volume of the MMC. In some aspects, the MMC/plunger combination is similar to macro-scale viscous-drag disk extruders, while in other aspects, the printhead resembles and operates similarly to drop-on-demand inkjet printheads. The orifice is relatively small in diameter compared with the MMC, and material may be retained in the MMC before extrusion in part by surface tension and in some embodiments, by already-extruded material blocking the orifice.

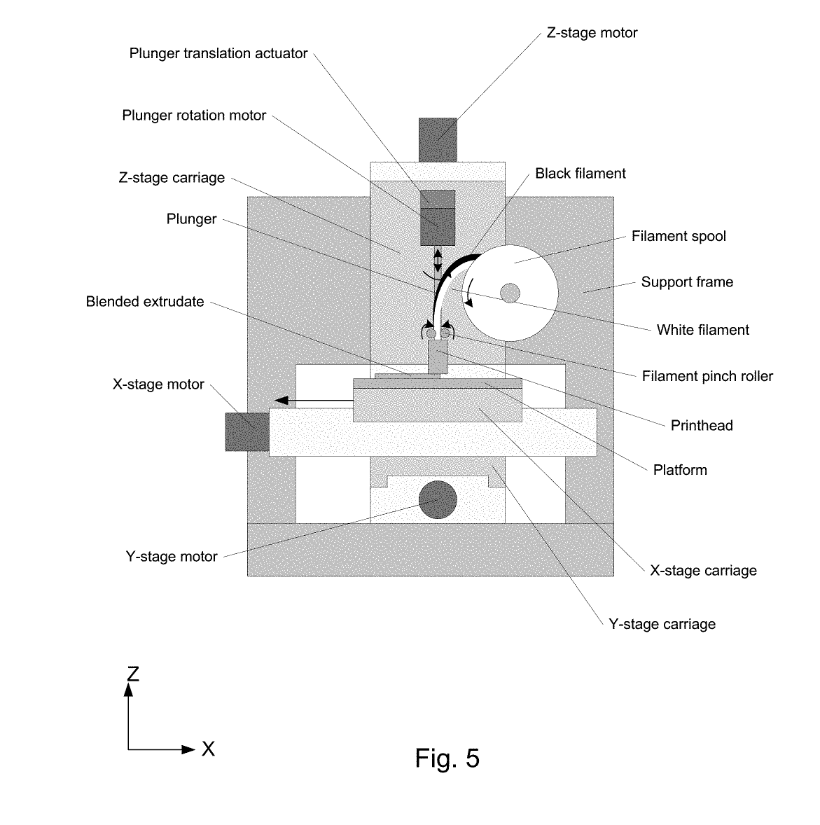

FIG. 5 shows a simplified implementation of apparatus for fabricating multi-material objects. The apparatus comprises a support frame with motorized stages for the X, Y, and Z axes. A platform on which the object is built is transported in X and Y by stages, while the printhead is translated along the Z axis. Other equivalent arrangements are also possible in some embodiments. Above the platform is mounted the printhead, from which extrudate issues onto the platform or previous layer. Entering the printhead are two filaments (e.g., 1.75-mm diameter ABS)—one black and one white—stored on spools, each of which is fed into the printhead by a pair of small motorized rollers. The plunger is actuated in translation along Z by an actuator and rotated around its longitudinal axis by a motor. Both the actuator and motor may be affixed to the Z axis stage. Not shown (among other elements) is the control system.

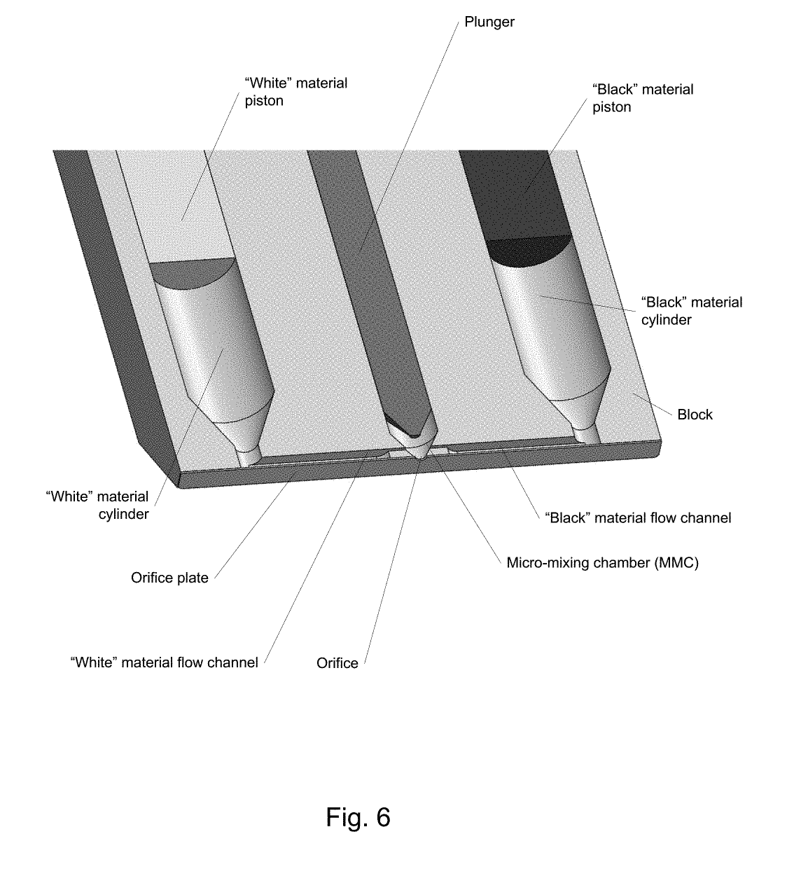

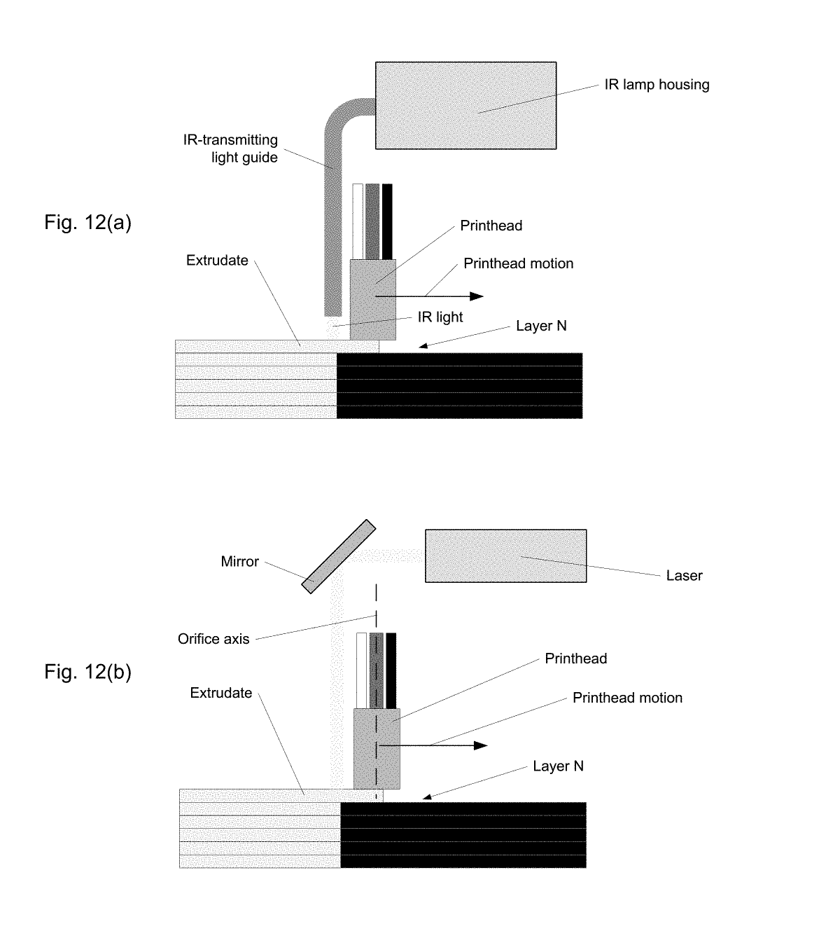

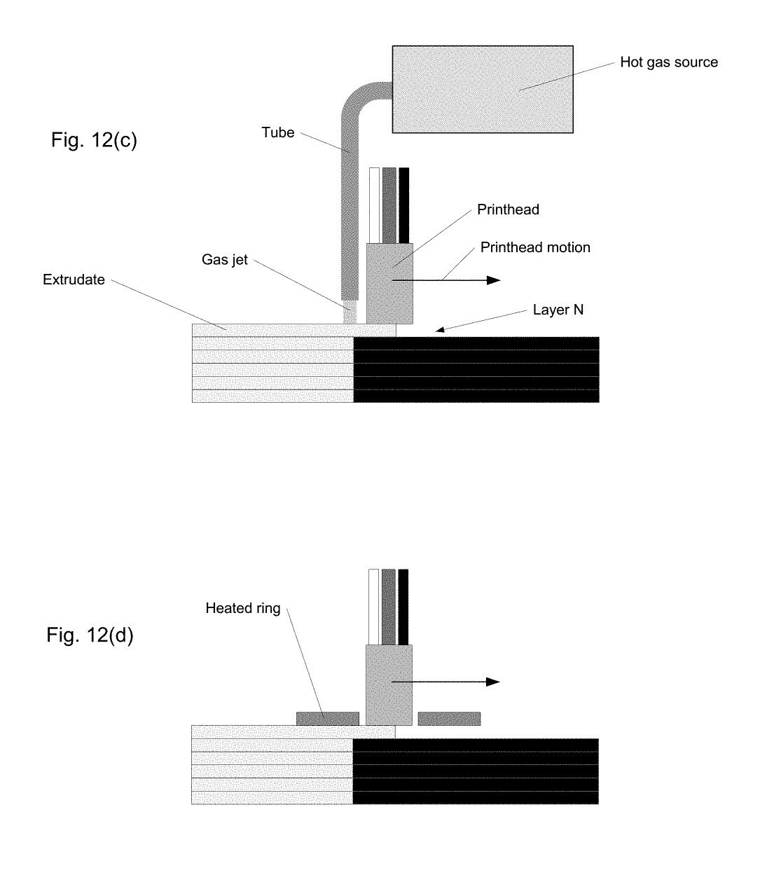

FIG. 6 depicts a similar printhead to that of FIGS. 3-4, but adapted to deposit non-thermoplastic materials such as thermoset materials. Here the printhead similarly comprises a block with cylinders and flow channels for each material. However, within each cylinder are pistons which pressurize and feed materials within the cylinders through the flow channels, into the MMC, and out through the orifice. In some embodiments, the pistons and cylinders may be separate and remote from the printhead, with material flowing into the printhead through tubing, while in other embodiments other methods of pumping the material, such as gear pumps, diaphragm pumps, and peristaltic pumps may be used. In some embodiments, the printhead cylinders may be at an angle to the vertical and the orifice may be at the tip of a tube or other nozzle, so as to minimally obstruct the extruded material from heated gas, light, or other means of curing, some of which are shown in FIG. 12. As before, rotation of the plunger allows rapid mixing of relatively high-viscosity materials such as silicones at low Re in the small volume of the MMC.

Methods of Operation

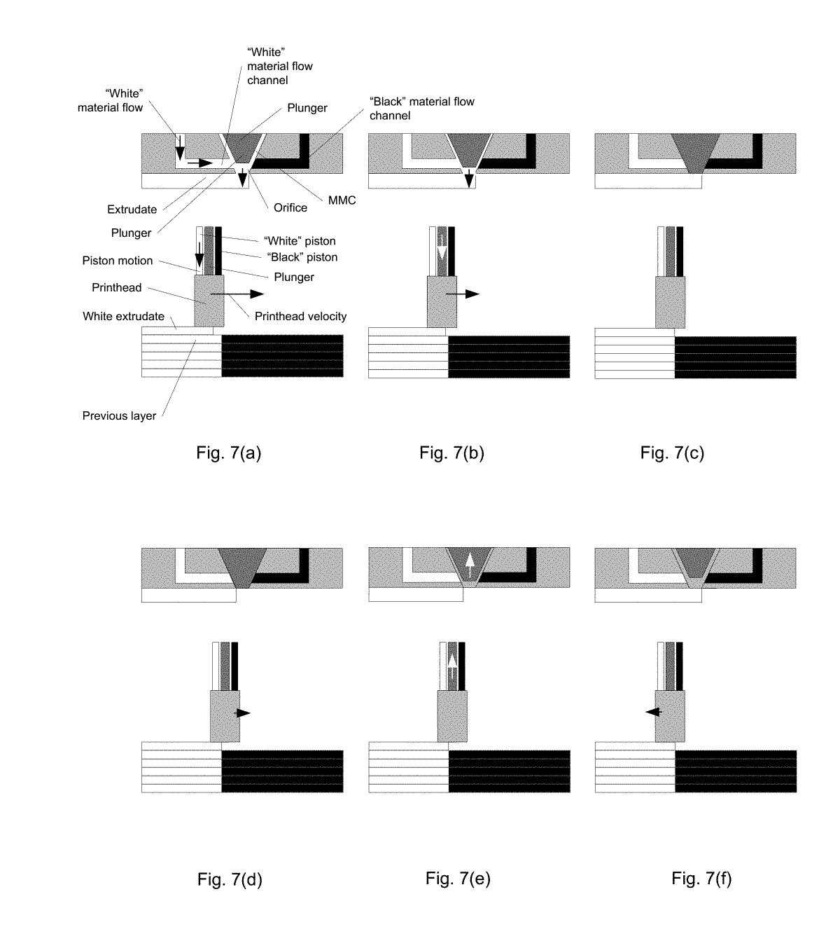

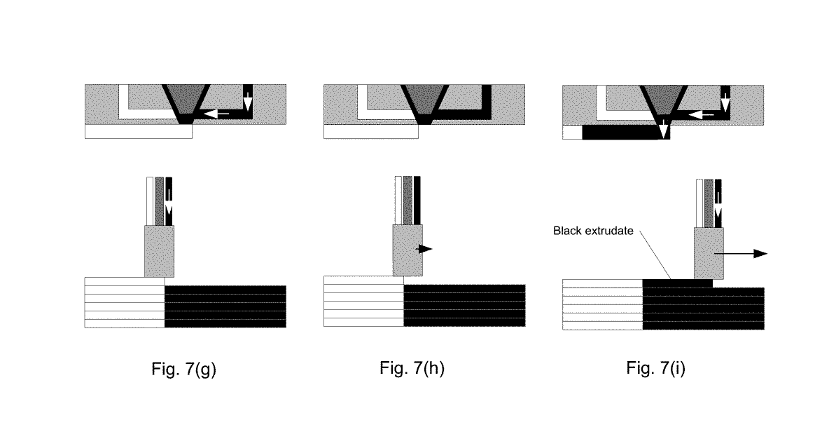

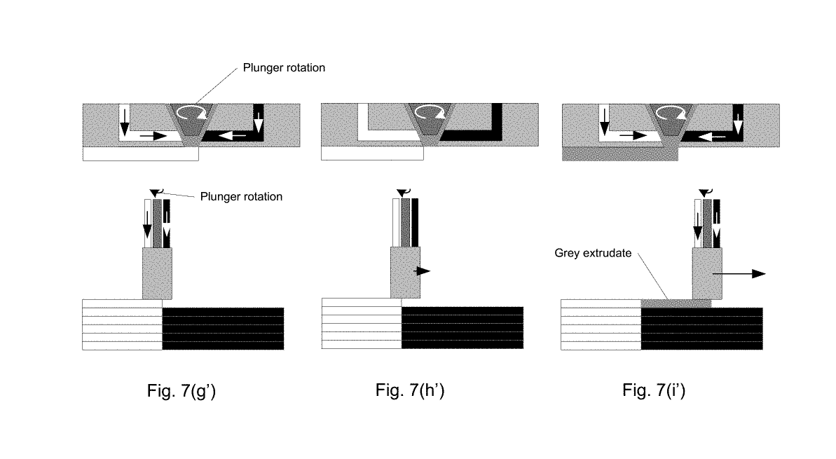

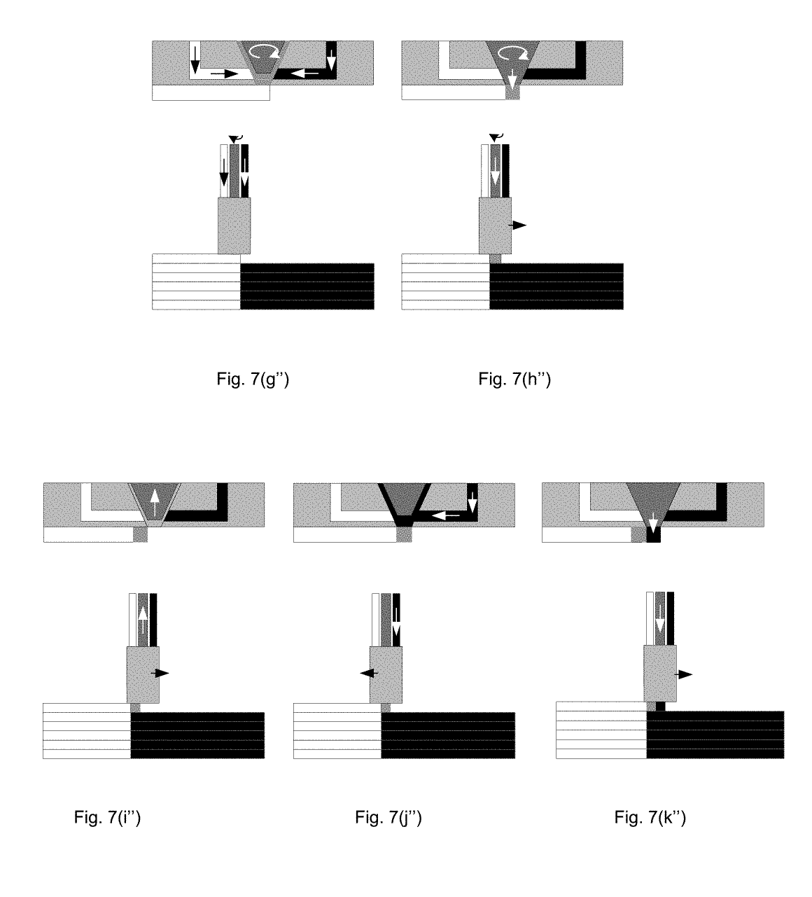

Several examples of methods of operation for the printhead will serve to clarify how a variety of extrudates, of both pure and mixed material, can be produced and used in the fabrication of a multi-material object. While a printhead of the kind shown in FIG. 6 or equivalent—with which non-thermoplastic materials are deposited—is assumed in these examples, the discussion applies equally to a printhead of the kind shown in FIG. 4 or other printheads through with which thermoplastic materials are deposited. In FIGS. 7 (a-f) the printhead is dispensing long or short black and white extrudates, each comprising a single material fed into the printhead. The steps involved in obtaining an abrupt transition between white and black extrudate are depicted, both with magnified cross sections through the lower end of the printhead (upper images), and with an overview of the printhead and deposited material (lower images). While the motions shown in FIG. 7 are described as discrete, non-overlapping, and sudden, in some embodiments the motions may be overlapping, simultaneous, accelerate or decelerate, etc.

In FIG. 7(a), the printhead is moved via an actuator controlled by a control system along toolpaths that are determined based on the geometry (and in some cases, material composition) of the layer of the object to be fabricated. The motion is at normal velocity, and the printhead continuously extrudes white material while the white piston is advanced by an actuator controlled by the control system, forcing material to flow through the white channel. Meanwhile, the black piston is not actuated, and no black material is within the MMC. The plunger is preferably at the top of its travel, allowing white material to flow with minimal resistance into the MMC.

In FIG. 7(b), the control system—knowing the volume of the MMC (which may vary as a function of plunger position; however, this is also known) and anticipating (based on data representing the object to be fabricated, which has been processed ahead of time) an imminent need to transition abruptly to black material at an upcoming location—stops (or slows) advancing the white piston when there is enough material in the MMC to complete the white extrudate, and begins to lower the plunger using an actuator so as to begin to purge the MMC while (preferably) simultaneously completing the white extrudate. The control system in some embodiments may also reduce the printhead velocity as shown in the figure. In some embodiments, a multiple purge action (pulsing the plunger up and down) can be used to help ensure a clean break of the extrudate from the print head, which allows clean transitions and helps to eliminate stringers. As the plunger descends, in some embodiments it also cuts off flow of material into the MMC, since the flow channels connect to the sides of the MMC. In FIG. 7(c), purging of the MMC has been completed as the plunger displaces the material in the MMC. The last of the white material has been extruded, finishing off the white extrudate to its correct length. With the MMC substantially empty of white material, black material can next be introduced with minimal risk of intercontamination, allowing abrupt transitions between materials. In some embodiments, should there be any contaminated/intermixed material, it may be purged into a waste container or to the side of the fabricated object or in a location on the object where it is harmless (e.g., in the interior), be wiped by a wiper, etc. The printhead may in some embodiments be stationary at this point, as shown.

In some embodiments, the printhead is advanced slightly beyond the extrudate as shown in FIG. 7(d) if needed to allow solidification of the extrudate (e.g., for thermoset materials, allowing the extrudate to be heated as in FIG. 12, or for thermoplastic materials, moving to a position such that the heated orifice plate or nozzle is no longer in contact with the extrudate, and optionally pausing to allow solidification. Next, in some embodiments, the plunger is raised/retracted, e.g., to its uppermost position, as in FIG. 7(e). Since there is no unsolidified extrudate beneath the orifice, none can be drawn inadvertently into the MMC while the plunger rises. As the plunger rises, in some embodiments the volume of the MMC is filled with air entering the orifice, and the plunger rises slowly enough to allow for this. In other embodiments in which the plunger rises quickly, a partial, temporary vacuum may be formed in the MMC, which may be used to help introduce material into the MMC. In yet other embodiments, material may be advanced into the MMC as the plunger is raised, to minimize the formation of a vacuum and the force required to raise the plunger, and reduce any risk of possible deformation of the orifice.

In some embodiments the printhead is then reversed slightly so that the orifice is at least partially blocked by the now substantially solidified extrudate as in FIG. 7(f). This minimizes the risk of premature extrusion of the material that enters the MMC in the next step. Next, in some embodiments the black piston moves (or e.g., for thermoplastic materials, the black filament moves) forcing black material into the MMC as in FIG. 7(g). Then, the printhead is advanced slightly in some embodiments as in FIG. 7(h) to place the orifice in a position to begin the black extrudate. Lastly, as in FIG. 7(i), the piston is advanced causing extrusion of black material to occur continuously while the printhead moves forward at normal velocity. In some embodiments, extrusion of black material begins as material enters the MMC (i.e., in FIG. 7(g)). While the two extrudates (white and black) are shown to be contiguous, they may not be necessarily.

It is assumed in the figures that the plunger is not spinning since in FIGS. 7(a)-(f), no mixing of materials is required; however, to avoid delays in stopping and starting rotation, in some embodiments it may be spun continuously. The control system must of course anticipate changes in material and orchestrate adjustments to material feeds, printhead speeds, and plunger motion and rotation accordingly.

In combination with FIGS. 7(a-f), FIGS. 7(g′-i′) depicts an alternative to the steps shown in FIG. 7(g-i) wherein the material transitions not to pure black, but to a mixture of both white and black. In some embodiments in FIG. 7(g′) the plunger (if not already rotating) begins to spin, and both the white and black pistons are advanced—at a relative speed that provides the desired proportions and total volumetric extrusion rate—pushing both materials into the MMC; mixed “gray” material also starts to extrude from the orifice. Then the printhead is advanced slightly in some embodiments as in FIG. 7(h′) to place the orifice in a position to begin the grey extrudate. Then in some embodiments in FIG. 7(i′), the printhead moves at normal velocity, continuously extruding gray material having a specified mix ratio. While the printhead moves, the relative speeds of the two pistons may be changed, producing compositional gradients in the extrudate along the axis of printhead motion.

In addition to the extrusion of long or short extrudates of homogenous or gradually-varied materials illustrated in FIGS. 7(a-i) and 7(g′-i′), micro extrudates may in some embodiments also be selectively deposited in regions of the fabricated object by operating in a pulsed/purging mode. In this case, extrusion is stopped and the MMC is filled with the desired material (or set of materials at the desired mixing ratio). This is mixed if necessary, and the MMC is purged by lowering the plunger to produce a micro extrudate of a size typically determined by the volume of the MMC (in some embodiments this can vary according to the initial position of the plunger). Following this procedure, another micro extrudate of different composition may be deposited or continuous extrusion of a short or long extrudate may occur. The production of two successive micro extrudates in some embodiments is illustrated in FIGS. 7(g″-k″), which replace and extend FIGS. 7(g-i).

In FIG. 7(g″) the plunger (if not already rotating) begins to spin, and both the white and black pistons are advanced—by a relative distance that provides the desired proportions and total volume of the micro extrudate—pushing both materials into the MMC while in some embodiments the orifice is at least partially blocked by previously-extruded material. In FIG. 7(h″), the printhead in some embodiments advances slightly forward and then the plunger descends, ejecting the mixed gray micro extrudate with the specified mix ratio. In FIG. 7(i″) the printhead is in some embodiments advanced beyond the grey micro extrudate and then the plunger is raised to create a suitable volume in the MMC. As already described, advancing the printhead can avoid drawing extrudate into the MMC, and may allow the extrudate to solidify.

Since the next micro extrudate will be of pure black material, in some embodiments the plunger rotation may be stopped; however, the plunger may continue to spin if desired during this and the remaining steps. In FIG. 7(j″) the printhead is in some embodiments returned so that the orifice is over the extrudate, minimizing the risk of premature leakage/ejection while the MMC is filled with black material. In FIG. 7(k′), in some embodiments the head is advanced and then plunger is lowered to eject the black micro extrudate.

When continuously extruding micro extrudates, each of which may have a different composition, the printhead thus operates in a pulsed mode, with the plunger oscillating/reciprocating up and down and the printhead (in some embodiments) advancing (and in some embodiments, reversing its motion) intermittently. Each time the plunger descends, it shuts off flow into the MMC from both flow channels and ejects the contents of the MMC to both form a micro extrudate and to purge the MMC in preparation for the next cycle.

Fabrication of objects as described above need not necessarily be significantly slower than conventional FDM even when material composition is varied significantly throughout a part. This is for several reasons: 1) the printhead may operate in a continuous mode most of the time, slowing down or stopping only when abrupt material transitions are needed; 2) if needed, multiple MMCs, each with its own orifice or connected to a common orifice (e.g., through a “Y” channel) can be used. For example, two MMCs (with associated hardware) operating out of phase with respect to one another (i.e., alternating extrusion and mixing) can be used to increase the pulsed mode duty cycle to close to 100% and minimize pausing or stopping of printhead motion: while material is loaded into and mixed in one MMC, it is ejected by the other. As an example of throughput if only one MMC is used, consider a part made entirely of 160 nanolitre micro extrudates measuring 0.25 mm in height (layer thickness) and 0.8 mm in width and length (length measured parallel to printhead motion). Assuming 30 ms for mixing and 10 ms for ejection/purging, then 25 micro extrudates can be produced per second, for a linear deposition rate of 20 mm/sec, which is very reasonable.

Materials

Among the thermoplastic materials suitable for use with the methods and apparatus described herein are materials such as ABS, nylon, polylactic acid, high impact polystyrene, polycarbonate, polyphenylsulfone, ABS-polycarbonate blends, polyester, and blends thereof. Among the thermoset materials suitable for use are thermally-cured thermoset polymers such as silicones, thiol-enes, polyimides, urethanes, epoxies, and vulcanized rubbers, and blends thereof, and ultraviolet and visible light-, or electron-beam cured materials including UV-curable silicones and thiol-enes. Other materials can also be used, including those which solidify by evaporation, by reaction with surrounding material, which do not solidify without further processing (e.g., after the object is fabricated), or which remain in a non-solid form (e.g., a gel). Hydrogels and other materials of interest to tissue engineering and regenerative medicine, and living cells or materials containing cells may also be used with the process. Polymers containing small particulate or fibers and which obtain final properties such as increased strength or to alter dielectric or magnetic properties without further processing [e.g., Nikzad, 2011; Shofner, 2003] are also possible.

With regard to thermoset materials, silicone elastomers are among some of the most promising materials for AM. The synthesis and properties of silicones are well-established and their applications are widespread, including their use in molded elastomeric parts, coatings, controlled-release materials, water repellents, and biomedical scaffolds [Clarson et al., 2000]. They are also commonly used in implants and prosthetics since short- or long-term implantable grades are available which can be completely polymerized by heating.

The primary molecular repeat unit in a silicone is [—SiR2-O—], where R is an alkyl or aryl organic substituent. The flexibility of the Si—O—Si linkage is reflected in the low glass transition temperatures (Tg) of silicones, and the presence of hydrophobic R groups gives silicones their water repellent nature. The silicon atoms in each repeat unit also give silicones good thermooxidative stability. Silicones are readily cured by a platinum-catalyzed addition process. The cure is a two-component process in which one silicone possesses Si—H groups and the other possesses alkene groups bonded to silicon (i.e. Si—CH═CH2). Mixing the two components in the presence of a platinum catalyst initiates addition of Si—H groups to the silicon-alkene groups, resulting in crosslinking and cure. The properties of the cross-linked material can vary widely, and are easily controlled by a number of variables including molecular weight of the starting materials, concentration of reactive groups in the starting materials, and the identity of the other R groups on silicon. As a result, platinum-cured silicones are widely used as heat-curable rubbers and injection moldable products. In a similar fashion, silicones can be cured to thermosets via a UV-crosslinking process in the presence of a photoactive catalyst.

One general variety of silicone is known as liquid silicone rubber (LSR). LSR materials are optimized for use in injection molding, and are supplied as two components which are mixed prior to molding. Because of their rapid thermal curing and high degree of shear-thinning, they are well-suited for use in a material extrusion AM process. Moreover, silicone normally adheres well to already-cured silicone, a critical factor in building 3-D structures from multiple layers. In some embodiments adhesion promoters are added as needed. Examples of commercial LSRs are those made by NuSil Technology LLC (Carpinteria, Calif.), which are available in a wide range of durometers and have a long pot life and high purity/biocompatibility. For example, by feeding two miscible, compatible grades—MED-4905 (7 Shore A) and MED-4980 (80 Shore A) in the desired proportions into the printhead and mixing in the MMC, silicone objects whose hardness can be spatially modulated (i.e., locally varied) over the range of 7-80 Shore A can be fabricated. To provide colors (e.g., for anatomical models) color masterbatches can be incorporated. For example, feeding four differently-colored silicones based on white, cyan, magenta, and yellow masterbatches to the printhead in the right proportions would enable a very wide range of colors to be produced.

A newer cure technology than silicones involves thiol-ene chemistry: the addition of thiols (—SH) to alkenes (—CH═CH2). Because thiol-ene reactions are extremely fast, clean, high-yielding, and insensitive to air and water, they are classified as a “click” reaction [Hoyle and Bowman, 2010]. Thiol-ene chemistry has been used extensively for the synthesis of cross-linked networks from component mixtures of polythiols and polyalkenes [Hoyle et al., 2004]. The advantages of using thiol-ene chemistry in this regard are minimal shrinkage and stress (which often cause distortion in AM-produced parts), high monomer conversions (improving biocompatibility, among other benefits), and uniform crosslink density. Glass transition temperatures are normally very narrow, reflecting high crosslinking homogeneity. Thiol-enes are inexpensive and attractive for a growing number of applications. For example, they can have impact resistance and energy absorption superior to materials such as polyethylene-co-vinylacetate often used in protective equipment such as mouth guards [McNair et al., 2013]. They are also being evaluated as a potentially superior dental restoration material. Additionally, bioresorbable networks can be prepared by employing degradable thiols as recently described [Jennings and Son, 2013], and a thiol-based biodegradable hydrogel has been explored as a delivery vehicle for human bone morphogenic protein-2 [P. Mariner et al, 2012]. Using methods and apparatus described herein, patient-specific mouth guards, dental restorations, and other medical devices can be manufactured. Thiol-enes can also have very good machinability, which can be important for achieving exact tolerances in AM-produced parts. Thiol-enes can be combined to yield a very wide range of properties, and can have relatively low viscosity, enhancing mixing. Thiol-enes have generally two liabilities: an unpleasant odor and a relatively short shelf life once mixed. These can be largely overcome through the use of material extrusion AM (in which the material is not exposed until extruded) and point-of-use reactive mixing.

Traditionally, thiol-ene networks are cured photochemically or thermally via a free-radical process. An ionic mechanism in which the addition process is catalyzed by small amounts of an organic amine or phosphine compound may also be used. Thiol-ene reactions proceeding via an ionic mechanism are often called thiol-Michael reactions. The benefits of this mechanism are that the addition/cure takes place at room temperature and the rate is controlled by the type and concentration of catalyst. Reaction completion times as short as a few seconds are possible. Exploiting this catalytic approach and adjusting the timing, it is possible to mix and rapidly extrude a thiol-ene and have it solidify as an extrudate without the need for thermal activation; this is not feasible without point-of-use mixing.

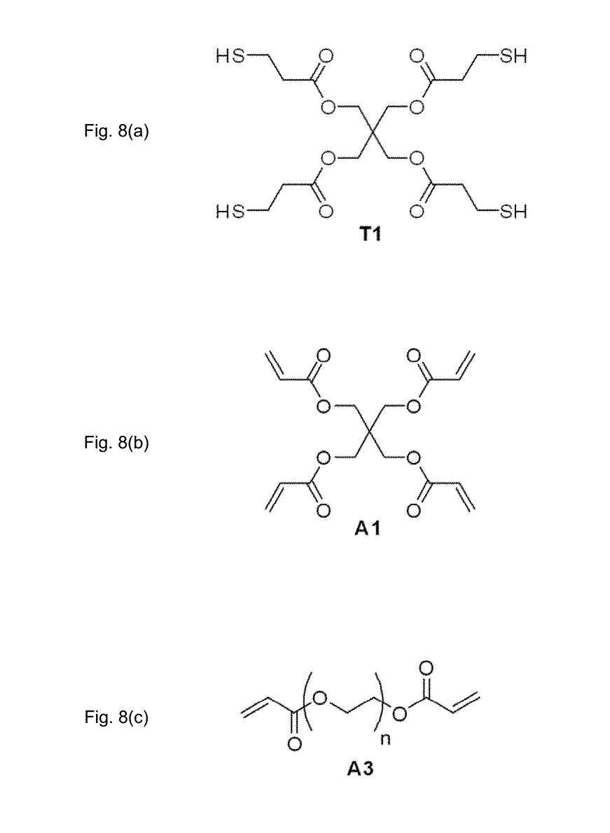

FIG. 8 depicts the chemical structure of some exemplary thiol and alkenes (enes), all of which are low viscosity liquids that will mix easily with one another. In any thiol-ene reaction, one thiol group (SH) reacts with one alkene group (==). Therefore, a given number of molecules of thiol T1 (FIG. 8(a)) requires the same number of molecules of A1 (FIG. 8(b)) for complete reaction, since both T1 and A1 contain the same number of reactive groups (four, in this case). By comparison, mixing T1 (tetrafunctional, with four active groups) with A3 (FIG. 8(c), difunctional, with two active groups) would require twice the quantity of A3 as T1. By decreasing the degree of functionality in the ene component, crosslink density will decrease. Generally speaking, reducing crosslink density results in decreased polymer hardness and elastic modulus. Therefore, a thiol-ene based on T1 and A1 will be harder and stiffer than one based on T1 and A3. Moreover, A3 can be obtained in a high molecular weight form that further reduces crosslink density, creating a large range of properties. By mixing a thiol-ene from T1, A1, and A3, for example (in a printhead that can handle three liquids), and smoothly varying the relative quantities of A1 and A3 (while maintaining the stoichiometry of reacting groups), properties of the mixed and extruded material can be varied. Indeed, while data available on material properties of thiol-enes is limited, a 10-fold change in the storage modulus has been obtained by changing the mixture ratio of some components tested [McNair et al., 2013] with three and two reactive groups. Using components with four and two reactive groups and further reducing crosslinking by using a high molecular weight ene enables a much broader range in material properties and can produce softer materials, for example. Such a crosslinking process can proceed via a photochemical or thermal free-radical mechanism or an ionic mechanism in the presence of a suitable catalyst such as an amine or phosphine.

Thermoset materials are often mixed before use from two or more separate components. For example, silicones are normally mixed from two components: one containing a catalyst and the other containing a crosslinker. If only one grade of silicone is to be deposited, then the two components can be separately fed to the MMC and mixed. In this scenario, the unmixed components can remain in the printhead and fluid delivery system for extended periods without harm. If, however, two or more different grades of silicone are to be mixed (e.g., to obtain a variable elastic modulus), then in some embodiments all components of all grades can be introduced into the printhead, while in other embodiments the components of each grade can be pre-mixed before loading, and only the pre-mixed materials need to be mixed in the MMC. This approach requires that unused, pre-mixed materials be cleaned out of the system before they spontaneously cure.

Thiol-enes can be cured after mixing two (or more) components, one of which is pre-mixed with a catalyst. These components can be fed to the printhead and mixed in the MMC. To spatially-modulate thiol-ene properties such as modulus, three or even four components can be metered into the MMC and mixed in variable ratios. The catalyst should be selected so that curing does not take place during mixing, but only upon ejection from the MMC and in some embodiments, after the addition of energy (e.g., heating). Alternatively, thiol-enes can be cured photochemically by exposure to UV radiation, typically in the presence of a photoinitiator catalyst.

Fluid Mechanics

An aspect of the subject matter described here is mixing of component materials, which in the case of some materials such as molten thermoplastics and silicones (though not typically thiol-enes) may be highly viscous. The blending time for the various materials must remain short so that overall machine throughput is reasonable. Moreover, the MMC volume must be small so that short micro extrudates may be formed, providing high spatial resolution in material composition. With some materials, perfect mixing is not required for good properties, but the better the mixing is, the more well-controlled the final material properties will be.

Although the scale of the mixing domain required is similar to many microfluidics applications, the mixing method described herein (high-speed plunger with a conical, spherical, or cylindrical geometry) differs substantially from those used in microfluidics devices because of the unique requirements of the printhead, including rapid purging of the volume and potentially high fluid viscosity (e.g., 100,000 times that of water). The vast majority of microfluidics mixers utilize long channels of various geometries to promote mixing [Nguyen and Wu, 2005; Capretto et al., 2011] which frequently require long residence times and a large mixing volume. Exceptions to this rule include vortex mixers [e.g., Lin et al., 2005; Long et al., 2009] and acoustic forcing [e.g., Ahmed, 2009]. However, vortex mixers work well only for Re ˜10-100 in water, which would require enormous flow rates to achieve for highly viscous materials and are thus not applicable for many polymers. The large viscosity of some of the materials to be mixed makes acoustic methods highly problematic. Rather, an approach using direct forcing with a mixing geometry that can be optimized for the desired mixing behavior is far more effective.

At a useful scale for the MMC (˜100 nanoliters), diffusion of species can take a minimum of minutes, making mixing by diffusion impractical. For this reason, forced/active convective mixing using a spinning plunger rotating at a high speed is used to promote mixing as rapidly as possible. As an example, consider a material with an effective viscosity of 100,000 cps at typical extrusion rates. For an MMC with a diameter of D ˜1.3 mm and a plunger of similar diameter spinning at 80,000 rpm, the Re of the mixing process is less than 0.04. Consequently, rapid fine scale mixing promoted by turbulence or even unsteady convective effects which appear at moderate Re (i.e., Re >100) are unavailable.

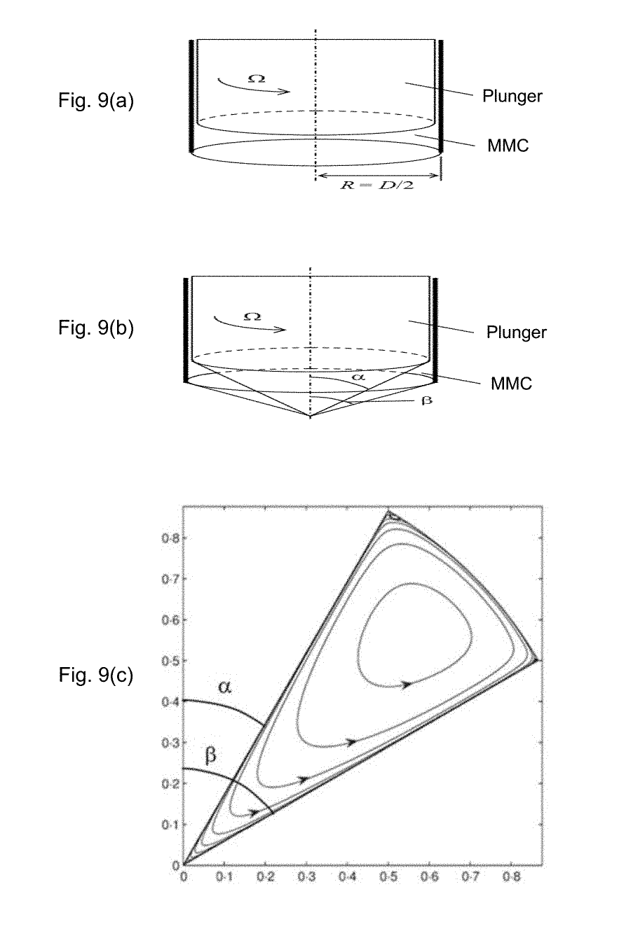

For the case of Re ˜0.01, mixing is determined directly by the motion of the plunger as it swirls the polymer components together though rotary motion. The simplest such arrangement is illustrated in FIG. 9(a), which illustrates a cylindrical MMC with the bottom surface fixed and the top surface rotating. For an anticipated residence time of 20-40 ms (e.g., in the pulsed mode of operation), the plunger will have rotated 27-53 times. This provides sufficient mixing of the fluid in contact with the plunger. However, the preferred geometry in this configuration is a short height, large diameter cylinder (to promote rapid mixing while minimizing volume) in which case the mixing will vary primarily linearly across the height of the MMC, with little mixing occurring at the bottom of the MMC for Re ˜0.01, though there will likely be some overturning of fluid and thus some top-to-bottom mixing as well. As a result, the level of mixing will tend to vary along the length of the extrudate rather than being sharply-defined, which can impede the curing process and disrupt the final material properties.

An approach to enhance mixing across the height of the MMC is to alter the geometry of the MMC in a way that promotes 3-D fluid motion to achieve overturning. One geometry that can accomplish this utilizes two cones with different half angles in which the inner cone spins to promote mixing, as shown in FIG. 9(b). In this case, the expanding geometry of the MMC with height (for α<β) promotes swirling motion in the meridional plane. FIG. 9(c) illustrates the streamlines in the meridional plane for one configuration of α and β defining the angles of two concentric cones at a particular rotation rate, as determined by the analytical and numerical analysis of Hall et al. [2007]. This theoretical work indicates that the 3-D vortical motion is much weaker than the driving motion and scales to order Re. For an Re on the order of 0.04, one can expect the fluid to overturn 1-2 times in the meridional plane for a residence time of 30 ms. While overturning more times will improve the mixing, overturning even once dramatically improves the overall mixing and provides nearly homogeneous extrudates. The results of Hall et al. [2007] show that the topology of the flow in the meridional plane is strongly dependent on the boundary geometry (α and β) and on the rotation rate (Ω), indicating that operating conditions may be tuned for optimizing mixing. In some embodiments, adding asymmetry to either the MMC or the plunger (e.g., adding to one of the cones a small recess or protrusion) results in more complex, 3-D streamline structures that promote increased 3-D mixing. In some embodiments the cones comprising the MMC have the same half angle (α=β) but are offset vertically; lowering the plunger can also completely purge the MMC. In some embodiments, oscillating the plunger along its longitudinal axis with appropriate amplitude and frequency may be used during mixing to provide more thorough and/or more rapid mixing.

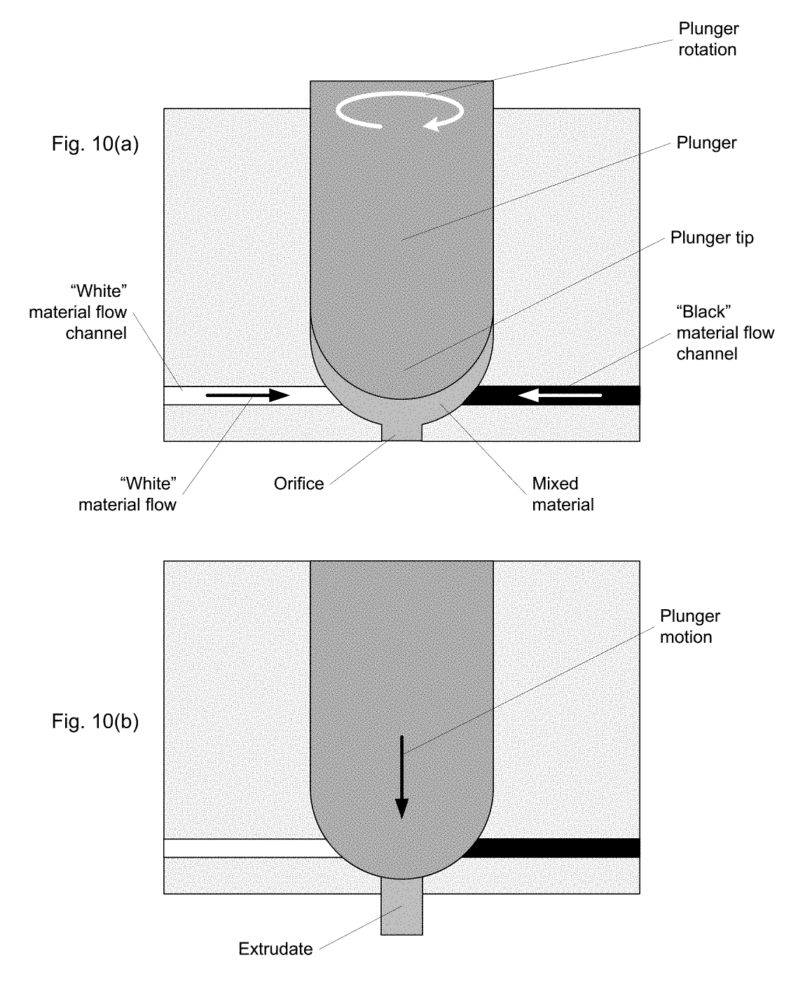

While using different cone angles promotes 3-D mixing, it makes complete purging by vertical translation of the plunger difficult. FIG. 10 depicts in cross sectional elevation view a printhead in some embodiments comprising an MMC shaped like a convex partial sphere (e.g., a hemisphere) and a plunger whose tip is shaped like a convex partial sphere (e.g., a hemisphere). When the plunger is raised as in FIG. 10(a), the cross-section of the MMC in the meridional plane is “half-moon” shaped. This shape is similar to the wedge shape illustrated in FIGS. 9(b-c), except that it is inverted (largest gap is on the bottom) and the walls are curved. Hence, it can promote mixing enhancement by overturning similar to that illustrated in FIG. 9(c) but also allows for complete purging of the MMC when the plunger is translated vertically to the bottom of the chamber (FIG. 10(b)). In some embodiments, the plunger tip and MMC can be provided with textures or features to enhance rapid blending, and preferably not interfere with complete purging. For example, one or more small protrusions on the plunger tip might fit into one or more cavities on the inner surface of the MMC (or vice-versa). When the plunger is raised, creating space within the MMC, the plunger can freely spin and the protrusions and/or cavities assist with mixing. When the plunger is lowered for purging, the protrusions can fit into the cavities, squeezing out any material that coats the protrusions or fills the cavities. In some embodiments the motor that rotates the plunger can have an associated encoder or other means for sensing its angle of rotation, thus allowing the plunger tip to be rotated so as to align the protrusions to their corresponding cavities before the plunger translates downward to purge the MMC. In other embodiments the plunger may be made free to rotate and the protrusions and/or cavities may be designed (e.g., with angled surfaces) to rotate the plunger passively as the protrusions enter the cavities.

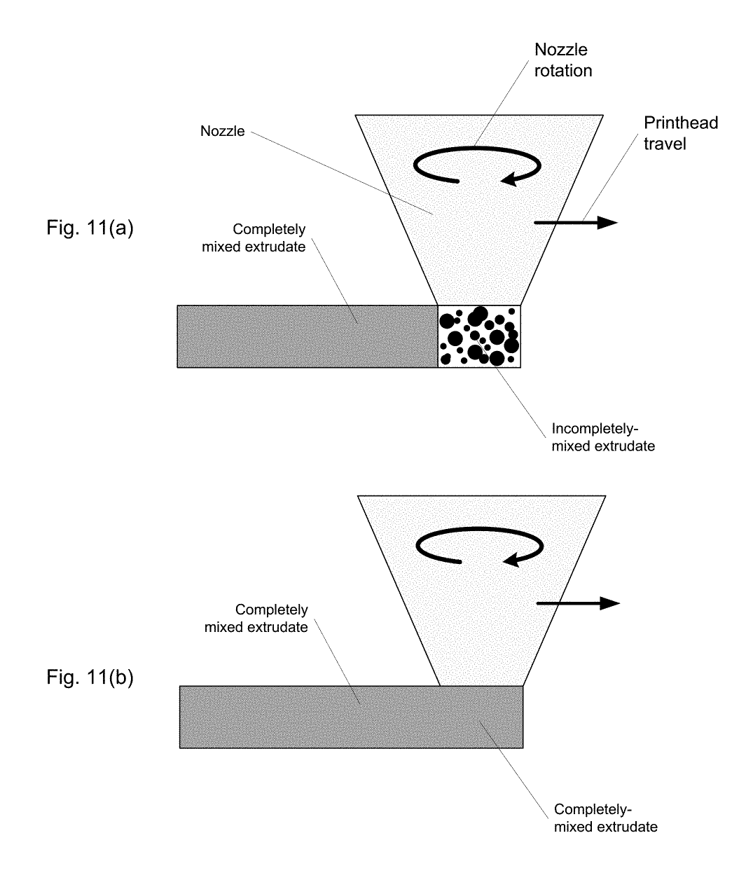

In some embodiments, material can be extruded from the orifice partially mixed or unmixed, with mixing occurring within the extrudate outside the printhead. For example, a rotating nozzle may be provided as in FIG. 11(a). Incompletely-mixed extrudate in contact with the nozzle (during and/or after extrusion) is mixed by the rotation motion (which in some embodiments also involves linear vibration along the axis of rotation and/or either or both axes perpendicular to it), yielding fully-mixed extrudate as in FIG. 11(b). For example, viscous drag on the extrudate due to contact with the bottom rotating and/or vibrating surface of the nozzle can substantially promote mixing. In some cases, the effective Re can be larger than for mixing within the nozzle if the characteristic length is larger once outside the confines of the nozzle interior. In some embodiment variations, textures or projections may be added to the nozzle tip to encourage mixing due to relative motion of tip and extrudate. In some embodiments, the nozzle may not rotate, but materials which are to be mixed are extruded from adjacent nozzles, preferably one downstream with respect to the other along the path of the nozzle, such that the thin layers of extruded materials can quickly diffuse into one another.

Metering and Mixing Ratios

As described, material is introduced into the MMC using a positive-displacement method such as a piston moving in a cylinder. In the case of thermoplastic materials, unmelted material serves as the piston. By using a relatively small diameter cylinder and a high-resolution drive, adequate metering control (e.g., <=30 nanoliters, or about 1/16 the volume of the MMC) can be provided. The minimum metering volume is preferably a small fraction of the MMC volume, since otherwise the number of possible mixing ratios can be relatively small since the volumes of all materials must sum to the MMC volume. For example, with two materials and a metering volume of 1/16 of the MMC, micro extrudates with 16 different mixing ratios (e.g., 16 different durometers) are possible. For longer extrudates, finely-graded mixing ratios can be provided by varying piston speeds.

Color and Support Material

A system for fabricating objects that are colored may use materials having at least four colors: white and the subtractive primaries cyan, magenta, and yellow. Black may be added in some embodiments to provide a better quality black than would be obtained by mixing all primaries. Opacity of these materials may vary from substantially transparent to substantially opaque, and in some embodiments additional materials may be added as opacifiers. Clear (i.e., uncolored) material may be added in some embodiments to create transparent regions of an object. To appear optically clear, regions of the final structure may be finished (e.g., sanding, polishing, reflow, solvent (e.g., acetone) vapor finishing, and chemical softening). The appearance of metal can be simulated by use of a clear resin that is filled with metal (e.g., Al) particles, similar to metallic paints.

In some embodiments support material (which supports structures during fabrication and is removed after part fabrication) may be delivered through the same printhead or a separate printhead. Support material is preferably soluble (and preferably in a non-toxic medium such as hot water, vs. a solvent); however, removable by melting, cutting, peeling, crumbling into small pieces or a powder, etc. are other techniques for removal. To enhance the strength of the mechanical connection between the fabricated object and the supports, especially in the case of materials such as silicone elastomers to which many materials do not adhere well, features may be provided in some embodiments on the fabricated object and/or supports which mechanically interlock the supports to the object. Such features may be designed in some embodiments so that they are hidden from view and/or do not interfere with the object's function. In some embodiments such features may be designed to be removed from the object. For example, the surface of a silicone object can include features with textures or undercut shapes such as those inspired by mushrooms or dovetail joints used in woodworking, such that these features are surrounded by the support during fabrication. Mechanical removal of the support may remove these features by tearing them loose, or they may be cut off, such as after the support is first removed by dissolution. The converse arrangement, in which the supports have undercut features surrounded by the object, may also be used in some embodiments, or a combination of both may be used.

Nevertheless, it has been found that certain materials which are able to be 3-D printed (e.g., by melting and extruding through a nozzle, e.g., of a syringe-type extruder) can have acceptable compatibility (e.g., adhesion and wetting of the surface) with respect to silicones (e.g., UV-cured silicones such as SILOPREN™ LSR UV Electro 225-1 (Momentive Performance Materials Inc., Waterford, N.Y.), either in pure form or with additives (e.g., additives to increase absorption of curing radiation)) and are readily dissolved after part fabrication. Such compatibility is mutual: silicone cured on them adheres to them, and the materials, when solidified on silicone, adhere to it. An example of such materials includes Sol-U-Cary Wax (Freeman Mfg. & Supply Co., Avon, Ohio). Other examples include polyethylene glycol (PEG) and poly(ethylene) oxide with molecular weights (MW) in the range of 5,000-40,000 and even higher (e.g., 1,000,000 MW), such as Carbowax (8,000 MW) or PolyOx WSR (100,000, 300,000, and 1,000,000 MW (both from The Dow Chemical Company, Midland, Mich.)) and PEG (20,000/35,000 MW) from Sigma Aldrich (St. Louis, Mo.), such as BioUltra 20,000. Other candidate materials are isomalt, maltitol, hydrogels, hydrocolloids, thermoplastic starch, alginate, corn syrup, sugar in its various forms, fat, wax, Crystalbond (Aremco Products Inc., Valley Cottage, N.Y.), and polyvinyl alcohol, possibly with additives. Some of these materials in their pure form may not be easily printed due to unsuitable rheological properties (e.g., too low in viscosity, not shear thinning), excessive shrinkage upon solidification, etc., but can be combined with fillers such as fine powders, nanoclay, etc. to improve their printability.

Some materials used for support (e.g., Sol-U-Carv, not to mention other materials that can be useful to 3-D print) may tend to segregate over time when melted. Thus a standard syringe extruder may be inadequate to ensure that a consistent composition of the material is provided during printing. Therefore, in some embodiments, a syringe extruder that can actively mix material while it is molten is desirable. According to one embodiment variation, a standard syringe extruder having a piston or similar plunger, or merely pressurize air which pushes on material within, can be equipped with a rotating or vibrating element such as a small mixing blade or propeller whose shaft passes through the device (e.g., through the piston) and is activated by an external motor, etc.

According to another embodiment variation, a magnetic stir bar (e.g., coated with an inert material such as PTFE) can be placed within the syringe and actuated by a suitably rotating magnetic field imposed through the syringe. Such a field can be provided for example by a ring magnet that is polarized across its diameter and driven mechanically while it surrounds the syringe. However, a less mechanically-complex method is to surround the syringe with a set of electromagnetic coils (e.g., similar to those used in a typical stepper motor) and associated ferromagnetic structures, if any. Suitably-phased currents can be applied to the coils, much as in a motor, to produce a rotating field that rotates the stir bar.

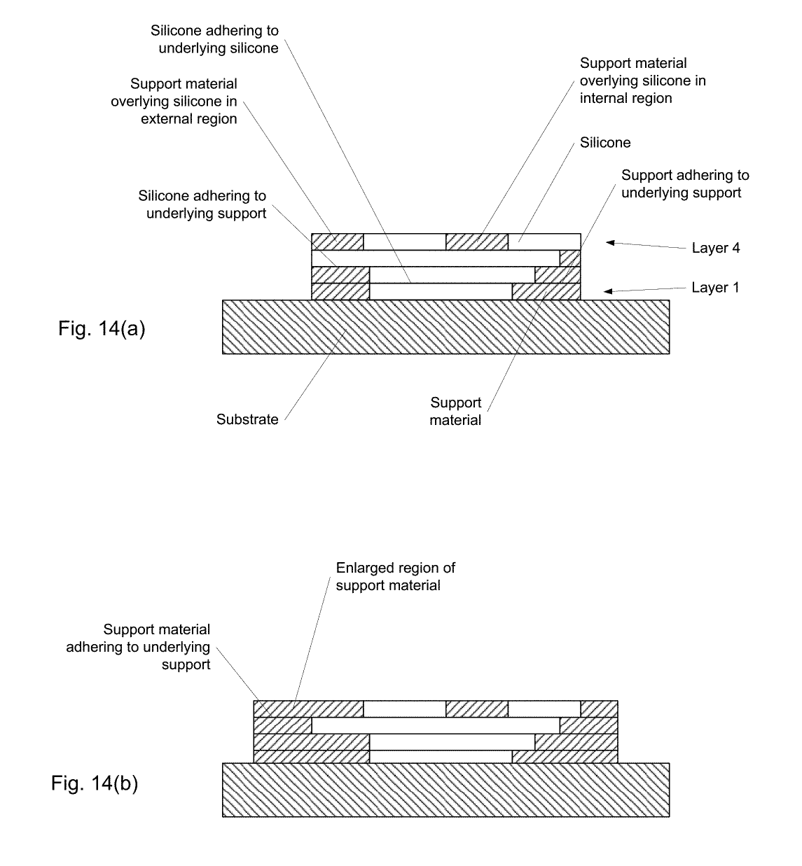

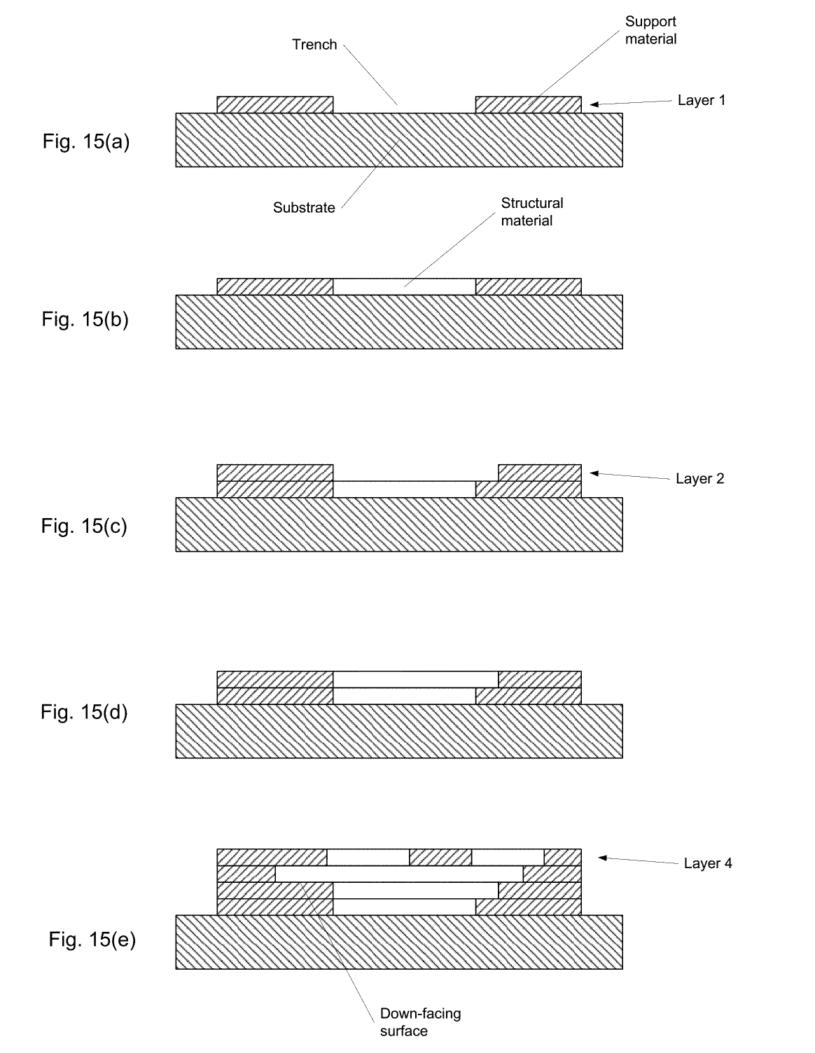

It is important that silicones have good compatibility with respect to the underlying support material when deposited (and in some embodiments, rapidly cured). However, in some embodiments compatibility need not be mutual i.e., the support material need not necessarily adhere very well to silicone as long as it adheres well to itself and if a suitable building method is used. FIG. 14(a) depicts a cross-sectional elevation view of a four-layer part comprising silicone and support material. On layers 1-3, silicone overlies either silicone or support material, so these layers can be formed if the compatibility of silicone with respect to itself and to support material is adequate when silicone is deposited over these materials. In layers 1-3, support material always overlies support material only—never silicone—so compatibility of support material with respect to itself is the key requirement.

In layer 4, however, support material overlies silicone in several regions; two such regions shown in FIG. 14(a). One region is internal and isolated—surrounded by silicone on all sides—while another is near the edge of the part. The former region can benefit from being surrounded by silicone in that if adhesion is poor, it cannot easily delaminate from the underlying silicone and slide parallel to the layer plane. However, for the latter “external” region, there is nothing to prevent the support material from doing so if its adhesion to the silicone is poor. Thus, a building method can be implemented in some embodiments as shown on the left side of the cross-sectional elevation view of FIG. 14(b). According to this method, additional support material is deposited around at least a portion of the border of the part. The result is that external regions of support material are enlarged and overly support material on the previous layer, to which they adhere well. This prevents potential movement of support material regions. Referring to FIG. 14(a), while there is no external region of support material on layer 4 on the right side, support material may optionally be added on the right side as shown in FIG. 14(b) so that the entire part is surrounded by support material and there is no exposed silicone. Thermal curing

In the case of thermoset materials, once the components are mixed (or if a single-component material, then without mixing), they often need to be cured using heat or light (e.g., ultraviolet). Like optical (e.g., UV, visible light) curing, thermal curing can be provided in some embodiments using an “extrude and cure” approach (thus the term “Extrude and Cure Additive Manufacturing”, or ECAM, may be applied) such as that shown in FIG. 12(a), in which extrudate is exposed to energy (e.g., thermal energy) shortly after leaving the orifice using light from a broadband IR (infrared) spot curing system (e.g., the iCure system of IR Photonics (Hamden, Conn.)) or a similar product by Full Spectrum Technologies (San Clemente, Calif.), or an IR system which illuminates over a broad area, including in some embodiments the entire layer. IR sources have already been used to quickly cure silicones [Huang et al., 1994; Reilly and Brunet, 2012], for example. In some embodiments, ultraviolet or visible-light cured thermoset materials such as silicone elastomers, acrylates, epoxies, and thiol-ene resins may also be used in conjunction with the methods and apparatus described herein, with light delivered to the material from a localized source (e.g., incandescent light, mercury bulb, light emitting diode, or laser), either in close proximity to the material to be cured, transmitted through at least one light guide (e.g., optical fiber or liquid light guide), etc. Spot cure systems such as the BLUEWAVE® systems made by Dymax Corporation (Torrington, Conn.) exemplify suitable systems for UV curing using metal-halide bulbs or short wavelength LEDs, though flood curing may also be used.

In some embodiments the extrudate can be heated by a laser (e.g., a CO₂ laser producing infrared radiation) as in FIG. 12(b). In some embodiments, the wavelength(s) of infrared radiation—whether delivered by a laser or not—are selected to penetrate through the thickness of the extrudate so that heating can be more uniform throughout the thickness of the extrudate. In some embodiments, non-infrared radiation may be used, such as ultraviolet, visible, microwave, and millimeter wave radiation. In some embodiment variations the laser is aimed not perpendicular to the layer as shown in FIG. 12(b), but at an angle so as to impinge on the extrudate closer to the axis of the orifice. In some embodiment variations multiple laser beams impinge on the extrudate; for example, a laser beam can be split and impinge on the extrudate from both sides of the extrudate, e.g., in a plane aligned with the orifice axis. In some embodiments the extrudate can be heated by a jet of hot gas (e.g., air) as in FIG. 12(c), such as can be delivered by the SMD Hot Air Pencil model ZT-2 made by Zephyrtronics (Pomona, Calif.). In some embodiment variations, more than one source or beam of light, more than one laser or laser beam, or more than one jet of gas may be used. For example, in order to minimize possible motion of the material when the jet impinges on it, at least two opposing jets may be provided to balance the fluid forces on the deposited material. For all these methods, the location of the heating must be continuously adjusted as the printhead moves through a complex 2-D path, such that the heating is always applied downstream of the orifice. In some embodiments at least a portion of the curing (e.g., UV or thermal) hardware (e.g., fiber collimator) can be rotated around the orifice axis, while in other embodiments the build platform holding the fabricated object can be rotated about an axis coincident with the orifice axis: this obviates the need to rotate the curing hardware. When a laser is used to provide the curing energy, the natural beam profile may not be suitable as-is, for example, in terms of uniformity. For example, a number of lasers produce a Gaussian beam profile, and so have greater intensity toward the center than near the edges of the spot. When such a beam illuminates the extruded material (which is moved underneath), the exposure of the material at any point along the width of the extrudate is proportional to the cumulative irradiance parallel to the direction of motion; this can be highly non-uniform. While defocusing the laser can help, beam shaping techniques know to the art [e.g., Dickey 2014] may be used, including Powell lenses and graded neutral density filters.

In some embodiments the extrudate can be heated by contact with a heated, non-adherent (e.g., PTFE-coated) surface. The surface can be for example a plate adjacent to the printhead, or preferably, a ring as in FIG. 12(d) which surrounds it and performs omnidirectionally such that no matter which way the printhead moves, the extrudate can be heated and cured. The plate or ring is preferably separate from, or at least thermally insulated from, the printhead, such that unheated material entering the printhead won't be prematurely heated by the plate/ring; moreover, it may be coated with a non-stick material such as Teflon®. Similarly, hot gas may be delivered through a ring-shaped slot in a manifold surrounding the orifice or a ring-shaped radiant heater surrounding the orifice may be used, curing the material regardless of the direction of the printhead at any moment in time.

Whatever the approach, the material must be heated rapidly and the heating sustained long enough for the material to cure at least partly (though support material can also help to support incompletely-cured material), establishing adequate mechanical strength, given the geometry, the supports provided, etc. In some embodiments, flowable material such as water or other liquid, or even powder, may be used to help support structures that are partially cured or made from low-modulus elastomers, e.g. through buoyancy. Curing can also be completed after the object is at least partially formed using an oven or other heat source if necessary. Thus, material requirements, thermal power density, size of the heated zone, and printhead velocity must all be considered and optimized for a particular layer thickness. In some embodiments, layer thickness is minimized as much as possible to speed curing. In some embodiments, curing is done at the highest possible temperature that does not produce damage to the material or a permanent change in properties. In some embodiments, the thermal conductivity of the material is enhanced through the addition of fillers (e.g., in the form of fine powders). For example, boron nitride (BN), available in powder from such companies as ZYP Coatings, Inc. (Oak Ridge, Tenn.), has a dramatically high thermal conductivity than polydimethylsiloxane (PDMS), so incorporating BN powder in a significant volume fraction into PDMS and similar materials such as LSRs can significantly accelerate curing.

A typical FDM toolpath is typically based on a vector (vs. a raster) approach and may involve first depositing “contours” of the layer along the boundaries of the layer geometry, and filling in the inside of those contours with additional extruded material (e.g., in parallel lines) known as “fill” (also called “infill”). The latter, however, involves large, fast movements of the printhead. In some embodiments, in order to expose the extruded material for a longer time to a heating source that is localized (e.g., laser, gas jet, heated surface) the toolpaths for printhead motions may be arranged so as to keep the printhead depositing material in a localized region of the layer as long as possible without significantly reducing productivity of the fabrication process. For example, the printhead may deposit extrudates for both contours and fill in a small area (e.g., 10×10 mm) while allowing the material time to thermally cure at least to an extent that provides mechanical stability, and then move on to form contours and fill in other areas. In some embodiment variations, these areas overlap, such that the printhead moves in a progressive fashion across the layer, and all material is exposed to heat for approximately the same time, or for at least a minimum time.

Using materials that are deposited in liquid, paste, or gel form, which require the addition of energy to solidify, and in which the energy is supplied locally to the material upon extrusion, then assuming that the curing radiation can be delivered to the extrudate downstream of the nozzle (by rotating the radiation source and/or the part as the nozzle moves, to remain substantially tangent to the trajectory), in-line curing may be achieved for the contours of a given layer. As for printing fill on the layer, a number of different approaches may be used. Parts can be produced using fill that is closely-spaced (with the goal of producing a solid part) or more widely-spaced (with the goal of producing a part more quickly, using less material, with lower effective modulus, density, acoustic impedance, etc.). Assuming especially the case of closely-spaced fill, the approaches include:

1. Printing fill unidirectionally by adjusting the energy source to an angle that allows illumination of the material upon extrusion (e.g., immediately downstream of the nozzle). Material is then extruded while the nozzle moves only in one direction, and is cured by the source without any shadowing by the nozzle.

2. Printing fill bidirectionally by adjusting the energy source after every fill trace is deposited, to an angle that allows illumination of the material upon extrusion (e.g., immediately downstream of the nozzle). Material is extruded while the nozzle moves in both directions (e.g., east to west for even-numbered extrudates, west to east for odd-numbered extrudates, in alternation, or at other angles (e.g. north-south/south-north, or at 45° to the X and Y axes), and again is cured without any shadowing by the nozzle. However, the energy source (or part) must execute a change in angle of approximately 180° at the end of each deposition, which can slow down the process. However, in some embodiments, the energy source(s) (e.g., LED) can be mounted to a lightweight (low moment of inertia) rotating element, and be supplied with current either using helical coils of wire (which allow rotation in one direction for a certain number of turns) or slip rings (which allow unlimited rotation); such an arrangement can allow rapid rotation.

3. Printing fill bidirectionally by using at least two energy sources (e.g., 180° apart) and adjusted to an angle that allows illumination of the material upon extrusion from at least two sides of the nozzle, and illuminate so that every fill trace can be illuminated by at least one source immediately after deposition. Material is extruded while the nozzle moves in both directions (e.g., east to west for even-numbered extrudates, west to east for odd extrudates in alternation) and again is cured without any shadowing by the nozzle, all without rotation of the energy source(s) or part. The energy sources in some embodiments are on continuously, while in other embodiments they are switched on and off in alternation, depending on which is active; this latter approach avoids potential re-exposure of neighboring extruded material by the source, which may be undesirable.

4. Printing fill unidirectionally by adjusting the energy source to an angle that allows illumination of the material upon extrusion (e.g., immediately downstream of the nozzle) and printing only certain extrudates (e.g., all even-numbered ones) while at that angle. Again, material is extruded while the nozzle moves only in one direction, and is cured by the source without any shadowing by the nozzle. The energy source (or part) can then be rotated (e.g., by 180°) so that it is positioned to cure extrudates printed in the opposite direction (e.g., odd-numbered ones). This approach is similar to raster generation using an interlaced raster, and requires much less rotation than approach #2 above. While undirectional printing can be relatively slow, depositing non-adjacent extrudates can be beneficial, especially for more rigid materials, in that stresses due to curing are decoupled when extrudates do not initially touch one another. Also, for all materials, the shape of an extrudate and the way it refracts incoming radiation—as well as its thermal environment—can be more symmetric with respect to surrounding material using this approach: an extrudate cured adjacent to another extrudate, as may be the case when printing fill, for example, may behave differently than when in isolation (e.g., as perimeter extrudates are often). It is worth noting however that to the extent the refraction is asymmetric, the beam profile can sometimes be modified or the positioning of the beam (including the use of multiple exposures) can sometimes be used to compensate for the asymmetry.

5. Printing fill bidirectionally but curing unidirectionally by adjusting the energy source (a single source to one side of the nozzle) to an angle that allows illumination of the material upon extrusion (e.g., immediately downstream of the nozzle). The energy source is defocused so as to span two or more extrudates. Thus, the extrudates are cured in groups of two or more—always while the nozzle is moving in one direction—while in the opposite direction, little or no curing occurs due to shadowing by the nozzle.

In some embodiments, material may be deposited in a raster approach using a single orifice or multiple orifices, defining the layer geometry using a set of parallel extrudates (the axis of which may be oriented differently from layer to layer). In such embodiments, heating of the material can be performed in a progressive fashion with heating means which cover a width sufficient to span the extrudates (e.g., a wide heated surface, a heated gas jet issuing from a slot) to provide heating over an extended period of time as the layer progresses. In some embodiments, if the material has reasonable mechanical stability—and especially if it is well supported—partial, complete, or additional curing can be provided by a heated roller which passes over the layer. In the case of a vector approach, this may be done after some of the layer is formed, or after all of the layer is formed. In the case of a raster approach, in some embodiment variations the roller may follow the printhead as it moves from one edge of the printed area to the opposite edge, delivering heat as it moves. In some embodiment variations, material may be deposited and then the deposited material is placed in contact with a heated surface covering a large area (e.g., the entire printed area, or a portion thereof). This can be achieved, for example, by moving the printhead out of the way and lowering a heated surface onto the layer, or raising the object to contact the surface.

Some structural materials (e.g., thermoset materials such as silicone) are difficult to 3-D print for one reason or another, or if they are printed, the surface finish, accuracy, optical transparency, or other desirable property is suboptimal. In some embodiments, rather than depositing such structural materials as with FDM (i.e., in a pattern so as to form a layer of a part), the geometry is defined by the support material, which is deposited first on every layer. Support material is deposited onto a substrate in a pattern that forms a trench, or cavity, into which the structural material can then be introduced: this is in effect a layer-by-layer casting process. This is shown in the cross-sectional elevation views of FIG. 15. In FIG. 15(a), support material has been deposited on a substrate in a pattern, leaving one or more trenches. In FIG. 15(b), the trench has been filled by structural material. If the structural material is not very flowable, it may be dispensed by a nozzle or other device which moves in a pattern to ensure that structural material is deposited substantially uniformly to fill all areas of the trench as in FIG. 15(b). If the material is flowable (e.g., a thermoset liquid such as silicone, epoxy, or a powder), it may be deposited within a single trench (assuming it is fully isolated without as much movement, or in some embodiment variations, without any movement), since the material can flow within the trench to fill it completely. Thus, for example a nozzle may dispense the material at an arbitrary location within the trench. In FIG. 15(c) support material has been deposited for layer 2, and in FIG. 15(d), layer 2 has been completed. After repeating this process for two more layers, layer 4 has been completed as in FIG. 15(e).

Using this method, the shape of the structural material on each layer can be determined largely or entirely by the shape of the support material, and the support material may be easier to control or print. For example, silicone, epoxy, and polyimide are thermoset materials which have the form of liquid, paste, or gel before curing. If extruded, they tend to slump and/or sag unless rapidly cured, even if somewhat shear thinning. Moreover, if they are viscous (as they often are) they can be difficult to extrude rapidly from a small nozzle without high pressure. Conversely, a trench formed from support material can be accurately defined in terms of position, sidewall shape, etc., especially if the material is a thermoplastic that rapidly solidifies upon extrusion. The geometry of the support is thus transferred to the structural material which is cast against it. Moreover, unless the trench is very narrow, it can be filled using a much larger nozzle, reducing pressure requirements and/or increasing speed. Also, the material within the trench is homogeneous, isotropic, and with potentially better physical properties than if the same volume were to be built up from small diameter extrudates issuing from a nozzle, since these may not merge, resulting in inhomogeneity (e.g., voids) and/or anisotropy, and poorer properties. Additionally, if allowed time to spread and settle, the material in the trench can be more uniform in thickness and its top surface flatter, allowing for more transparency of non-opaque materials, as opposed to mere translucency. Also, by increasing contact area between layers and between extrudates, inter- and intra-layer adhesion can be improved. In general, spreading of the dispensed material may be enhanced by vibrating the substrate. In some embodiments, to improve the flatness of down-facing surfaces of layers (i.e., surfaces facing the substrate as in FIG. 15(e)), the support material below the down-facing surface can be printed with a nozzle having a smaller orifice and/or using a smaller spacing between the extrudates which comprise it, and/or a material that planarizes the topography of the surface such as a planarizing coating made by Futurrex, Inc. (Franklin, N.J.) can be applied, and/or (if the material is thermoplastic) the up-facing surface of the support material can be locally or globally reflowed (e.g., with an IR illuminator, laser, or hot air).

In some embodiments, material deposited into a trench can be planarized/smoothed, e.g., by wiping with a doctor blade, rolling with a roller, or contacting with a flat plate before curing, or after curing, by machining methods.

Ordinarily, the speed of a nozzle may vary while depositing material to form a layer (e.g., being lower when rounding corners than when moving in along a straight or gently-curved toolpath). As the nozzle speed varies, the flow rate may also vary proportionately, such that the width of the extrudate produced is substantially constant. Assuming a constant with (and layer thickness), the exposure to curing energy should be in some embodiments also constant. However, since exposure is proportion to irradiance (e.g., Watts/cm²) of the curing energy and inversely proportional to the speed at which the source of curing energy moves relative to the material, if the source slows down (e.g., to round a corner) the irradiance should also be decreased. Thus, in some embodiments it is desirable for the intensity of the curing radiation to be adjusted dynamically as a layer is formed.

In some embodiments when a part is fabricated, the perimeter of each layer is first formed by extruding material, and then the fill for that layer is formed (e.g., by depositing a set of parallel, closely-spaced extrudates, typically with variable length). Curing may be achieved rapidly by illuminating the extruded material with suitable radiation (e.g., UV or IR), and this may be necessary to avoid slumping and/or sagging of the material (depending on how viscous and shear thinning it is). However, sometimes it is desirable to delay curing, or to cure only partially, to allow the material to flow somewhat to fill gaps (e.g., to make water/airtight), bond to adjacent extrudates more completely, form a smoother surface, etc. Therefore, a control system and/or software which pre-processes part geometry files to produce toolpaths and machine control commands, can locally alter the on time, off time, and intensity of the curing radiation in accordance with the local geometry and functional requirements (e.g., freedom from porosity in a fluidic device, transparency). In some embodiments at least a portion of the curing process may be delayed until after all extrudates have been deposited for a given layer or group of layers. For example, the nozzle may deposit material to form a layer and then repeat the set of toolpath motions (e.g., in the same order) with the source of curing radiation, such that the first material to be deposited is also the first to be cured. In such a case, if depositing and curing occurs at the same speed, then all regions of the layer will have an equal time to flow before curing. In some embodiments, material can be cured in more than one pass (e.g., curing material further but allowing it to cool between passes so as not to overheat it); the toolpath followed during curing of extruded material can be repeated exactly (the first time material may also be deposited). In some embodiments, blanket exposure of the material to curing radiation may be performed after at least a subset of extrudates are deposited for a given layer.

In some embodiments, curing may be adjusted to the local geometry. For example, the layer perimeter may be deposited and immediately cured to provide a well-defined, accurate contour, while the fill within that contour is allowed to flow for some time before curing. In some embodiments, it is easier to delay curing (e.g., if the curing radiation source is affixed to the deposition nozzle) in a region of the layer in which the toolpath is substantially straight, versus curved. Thus, in regions in which a delay is desirable, the toolpaths may be determined so as to facilitate such delayed curing (e.g., they may be made straight in such regions, and the effect of this on other regions accommodated).

In some embodiments in which the curing radiation can be precisely focused (e.g., using a laser), a single extrudate can be non-uniformly cured. For example, by focusing radiant energy on the center of an extrudate and allowing the sides to be less exposed, curing along a centerline of the extrudate can be greater than along the sides. This can be used to stabilize the shape of the extrudate while allowing material on the sides to flow somewhat (e.g., for fill, allowing one extrudate to blend into another). The sides can then be cured later: either before progressing to the next layer or after a number of layers have been built.

In some embodiments, inter-layer adhesion (e.g., between silicone layers, or between the structural and support materials) may be less than desired. This can be ameliorated by treating the printed layer with plasma (e.g., atmospheric plasma), UV, ozone, a chemical, etc., either locally or globally. Local treatment of layer N can be performed, for example, just upstream of the nozzle that is depositing material for layer N+1.

It is often desirable when using toolpaths which include arcs for the arcs to be smooth, accurate, and at constant speed. Curved elements in the part design normally are represented by the tessellated triangles of the .STL file, and so are polygonal, not smooth. However, G-code (used for CNC machine tools and 3-D printers) supports smooth arc commands. Therefore, in some embodiments, the .STL file can be analyzed so as to extract arcs, allowing replacement of what would normally a set of linear G-code commands which approximate an arc, with one or more suitable arc commands. For example, once an .STL file is “sliced” at a particular height, a series of segments or vectors representing contours is obtained. An algorithm can then be used to identify vectors which are a) head to tail (i.e., the coordinates of one head match coordinates of another tail); b) form a chain; and c) are at equal relative angles to one another. Once such a group of vectors is identified, the G-code commands for the group can be replaced by a single G-code arc command, providing a smooth circular interpolation. Deriving arcs from the .STL file before slicing is also possible.

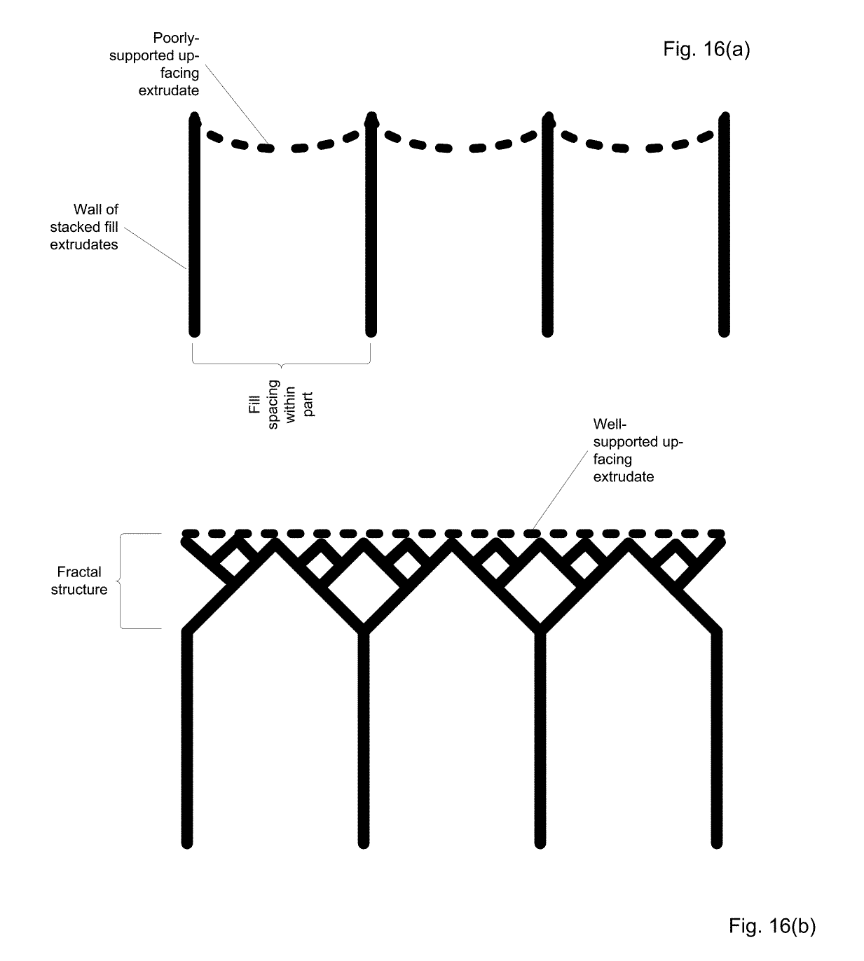

Elastomeric parts (e.g., made from silicone or a thermoplastic elastomer) can be produced, as noted, with fill extrudates that are not closely-spaced (i.e., not as a solid part). However, when using a material such as silicone that is a liquid or a paste and must absorb energy to solidify, it can be challenging to print up-facing surfaces when the underlying fill is widely-spaced as shown in the cross-sectional elevation view of FIG. 16(a), since there is little support for the material. Several methods can be used to deal with this situation. In a method used in some embodiments, the up-facing surfaces are printed using more layers so that if the lower layers are not well defined due to sagging, etc. of the material into the spaces between fill extrudates (FIG. 16(a)), they will not be visible, and these layers will nonetheless provide support for the upper layers of the up-facing surface. FIG. 16(a) only shows one of the lower layers of the skin attempting to bridge widely-spaced walls formed by fill extrudates; the layer is shown sagging, but in fact it may collapse into the space between the walls for want of adequate support. An alternative method used in some embodiments is to gradually reduce the spacing of the fill as the up-facing surface is approached, keeping the wall angle above the angle (relative to the horizontal, typically about 45°) which allows structures to be produced without supports, and to generate new, smaller “branches” as needed. The result is the fractal-like structure shown in the cross-sectional elevation view of FIG. 16(b), which provides far better support for the up-facing layer(s) (indeed, only one may be needed). The fractal structure may be one-directional (e.g., an extrusion of that shown in the figure) or be two-direction (e.g., converging in X and Y such that pyramids are formed).

In some embodiments, layers of thermoset materials such as silicone can be smoothed (e.g., to enhance transparency), and small gaps filled (e.g., for water/airtightness) by rolling over them with a roller coated in a thin layer of material. The material can be cured immediately in the wake of the roller. The material on the roller can be in a thin film so it doesn't fill in small holes and grooves that are intended to be present.

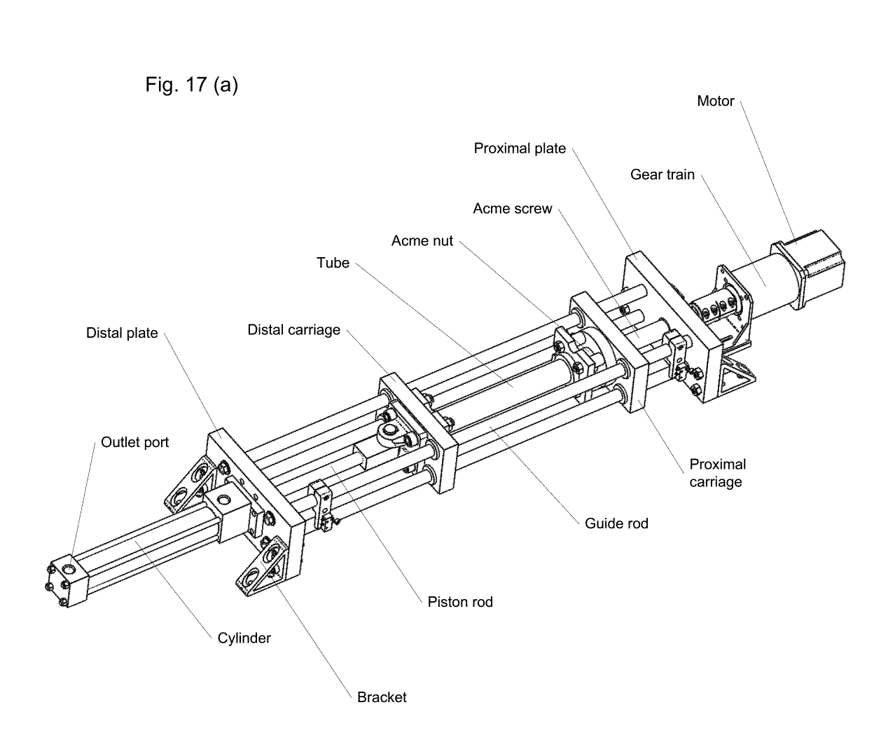

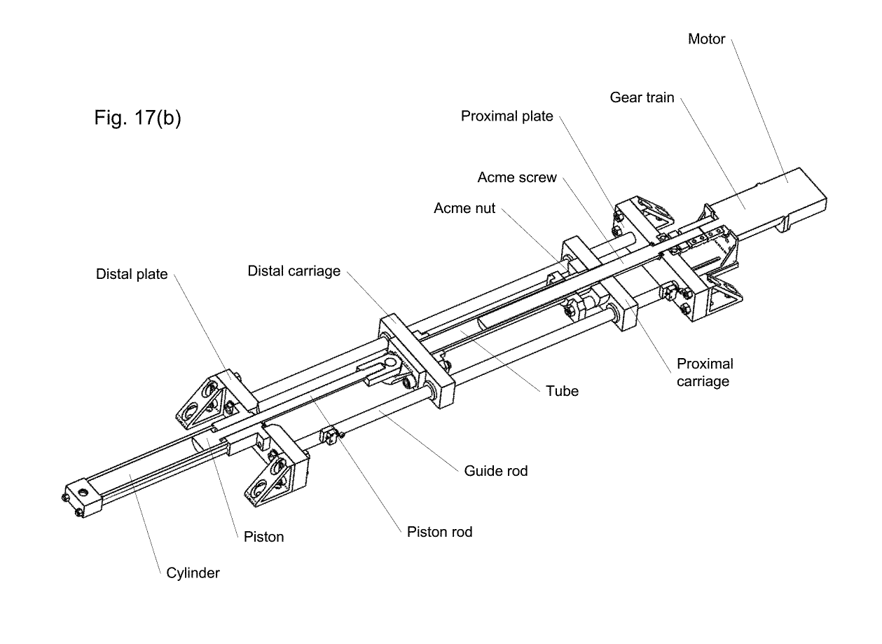

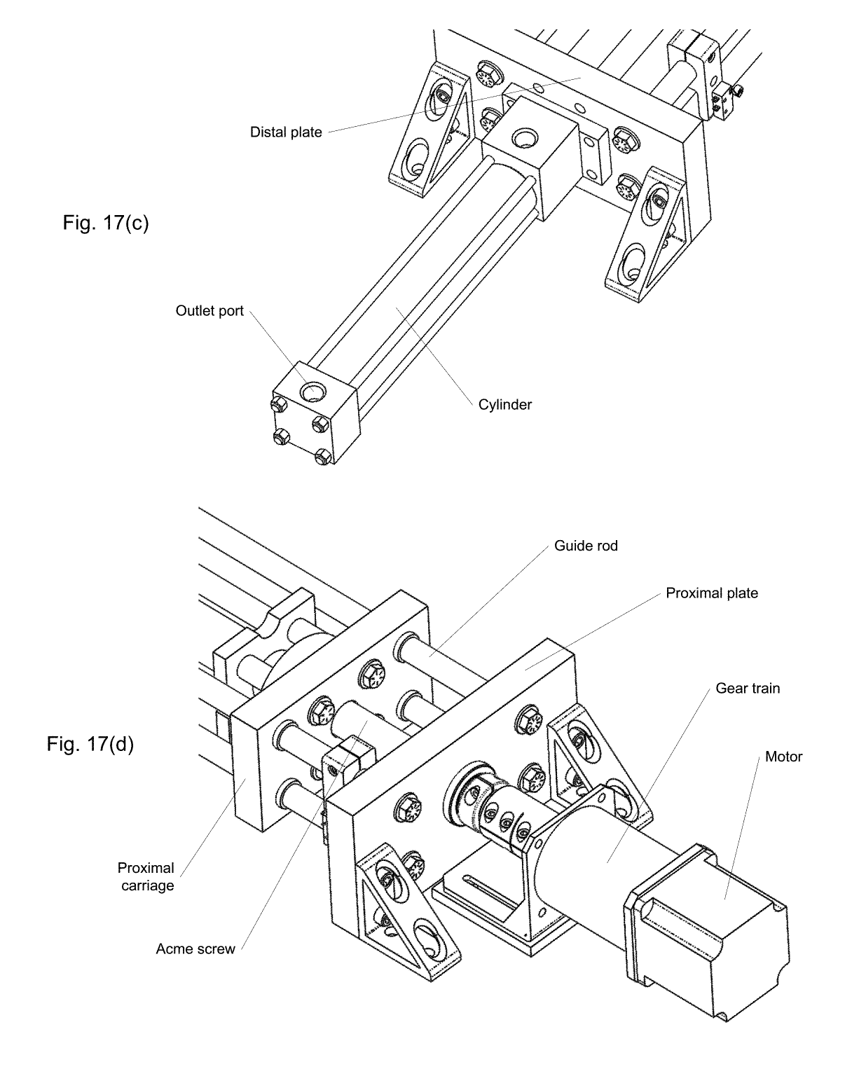

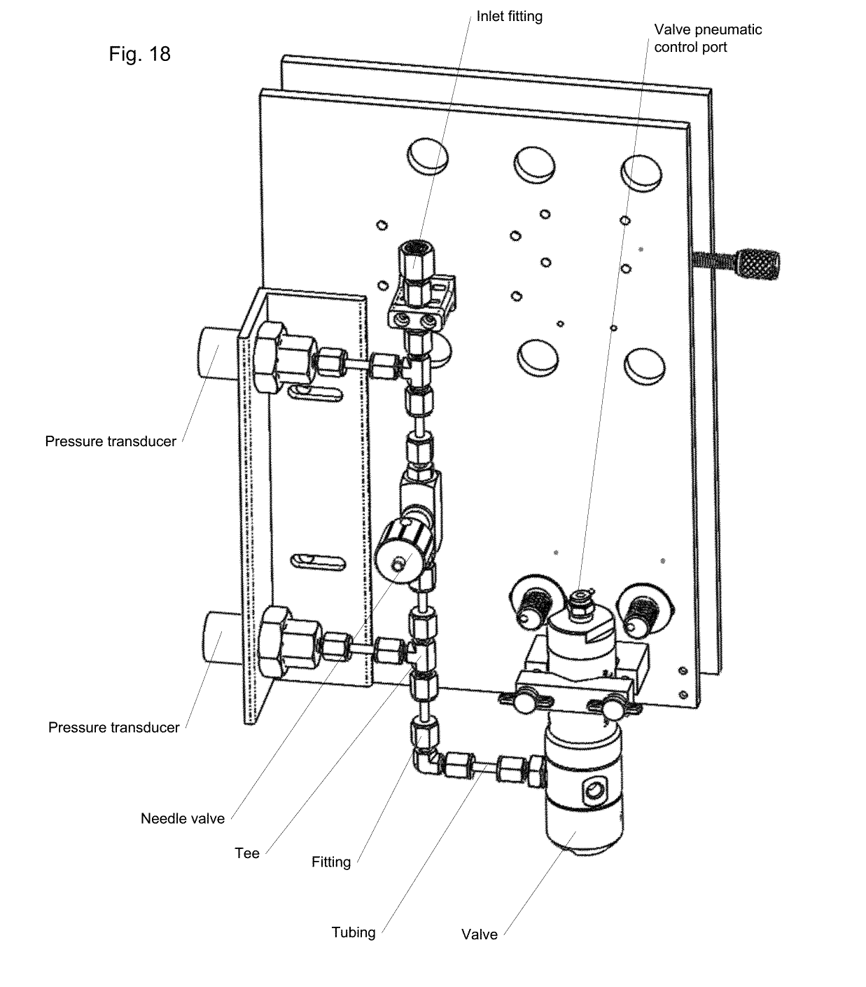

FIGS. 17(a)-(d) are 3-D views depicting a ram used to pressurize materials—especially high viscosity materials such as certain silicone elastomers (e.g., liquid silicone rubbers (LSRs)) for use in an AM system. A ram of such a design can achieve pressures in the range of 2000 PSI. High pressure may be needed to allow very viscous materials (in liquid, paste, or gel form) to be extruded through a small orifice (e.g., 100-500 μm) at high speeds, allowing rapid printing. The ram comprises a cylinder (e.g., a hydraulic cylinder) containing the material to be extruded (a pre-mixed two-part silicone, a single part of a two-part silicone (in which case two such rams may be used), etc.) The cylinder is mounted to a distal plate which is itself mounted through brackets to a support plate (not shown) adjacent to the ram components. The cylinder is provided with an outlet port which allows connection to downstream, distal portions of the material delivery system such as those which will be described in connection with FIG. 18. As is shown in the cross-sectional 3-D view of FIG. 17(b), the cylinder contains a piston, and the piston is joined to a piston rod which is pushed distally (towards the cylinder port) by a distal carriage. The distal carriage is joined to a proximal carriage by a tube, and both carriages travel along guide rods by means of bushings or linear bearings. The proximal end of the guide rods is mounted to a proximal plate which is itself mounted to the support plate. Fastened to the proximal carriage is a nut (e.g., an Acme nut), which causes the proximal carriage, tube, and distal carriage to move when a screw (e.g., an Acme screw) is rotated within the nut. The screw is driven by a motor (e.g., a stepper motor or a servo motor) which—if it has inadequate torque or resolution—drives the screw through a gear train as shown, connected to it via a suitable coupler. When the motor is turned, the piston advances or retreats within the cylinder, ejecting material from the port, or retracting material from the port, as may be required after an extrudate has been deposited and prior to a jump in the printhead position (to reduce the likelihood of stringers). In some embodiments, a high-pressure ram of similar design, but one which is heated, can be used to feed thermoplastic materials in a 3-D printer.

FIG. 18 is a 3-D view of the downstream components of a fluid delivery system. The outlet port of the ram shown in FIG. 17 may be connected (e.g., through flexible, high pressure hydraulic tubing) to an inlet fitting, which through tubing and fittings conducts material to a valve used in some embodiments, equipped with an extrusion nozzle which is opaque with respect to the curing radiation. The valve preferably has a small dead volume and can be actuated by a number of methods (e.g., pneumatic, electric) and serves to shut off flow from the nozzle, and preferably, to help “snuff-back” or retract the flow so that it doesn't continue to ooze or dribble when flow should be stopped. In some embodiments, a diaphragm, piston/cylinder combination, bellows, or other variable-volume device may be incorporated upstream of the nozzle (e.g., close to it) so that when the flow is to be stopped or its rate diminished (e.g., when slowing down the nozzle to make a turn of small radius), the device can expand to reduce the pressure that might otherwise cause oozing/dribbling. Raising the nozzle relative to the extruded material (e.g., by 0.5 mm) can also help; the valve can be closed and the nozzle raised at the end of each extrudate.

An exemplary valve is the 736HPA-NV high pressure balanced spool valve (Nordson EFD, East Providence, R.I.) shown in the figures, which has an adjustable snuff-back cutoff and is pneumatically controlled. As shown in FIG. 18, en route to the valve a needle valve or other flow-control device may be provided in some embodiments, allowing regulation of flow to the nozzle and affecting transient behavior of the flow. In some embodiment variations, the needle valve can be motorized so that the flow can be adjusted dynamically with a pressure-driven system (e.g., in accordance with the nozzle speed, so that extrudates are of a constant width regardless of nozzle speed). At least one pressure transducer may be provided in some embodiments, for example upstream and downstream of the needle valve as shown. The transducer(s) may be used to determine when the system pressure has reached a level suitable for operation, e.g., during priming of the system with material (to prime, the ram is advanced until there is flow from the nozzle and the pressure is steady), to identify problems with the fluid system such as blockages, etc. A pressure release valve may also be provided (not shown) to safely release excessive pressure from the system.

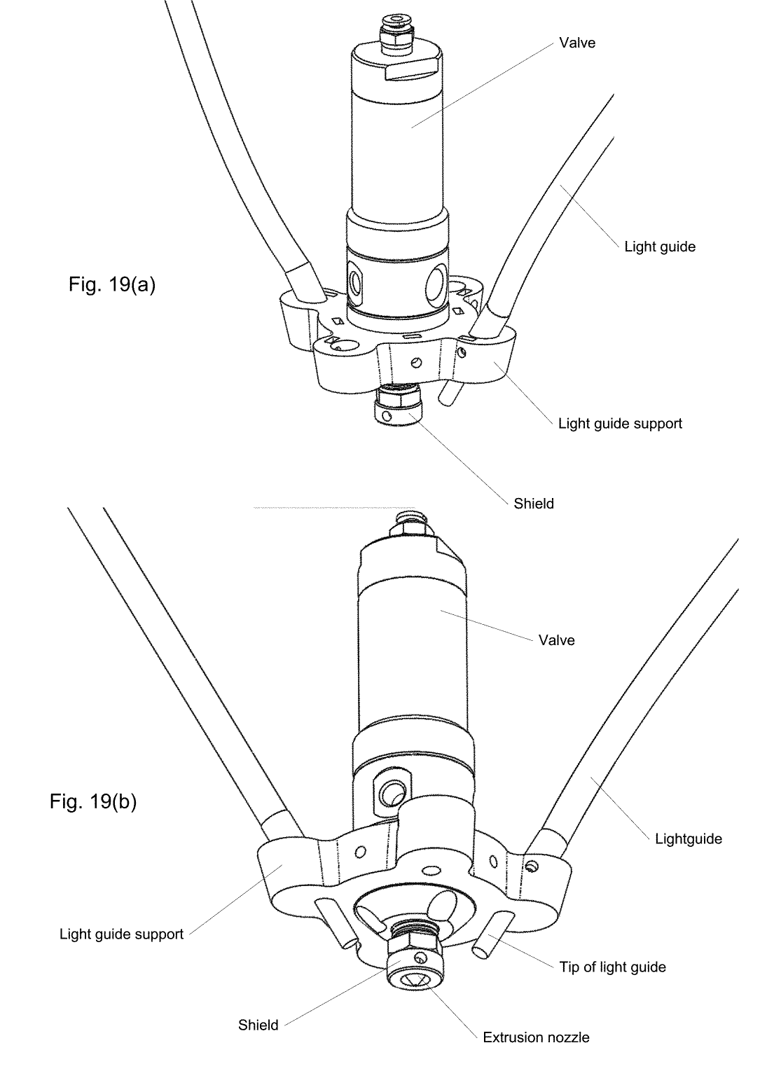

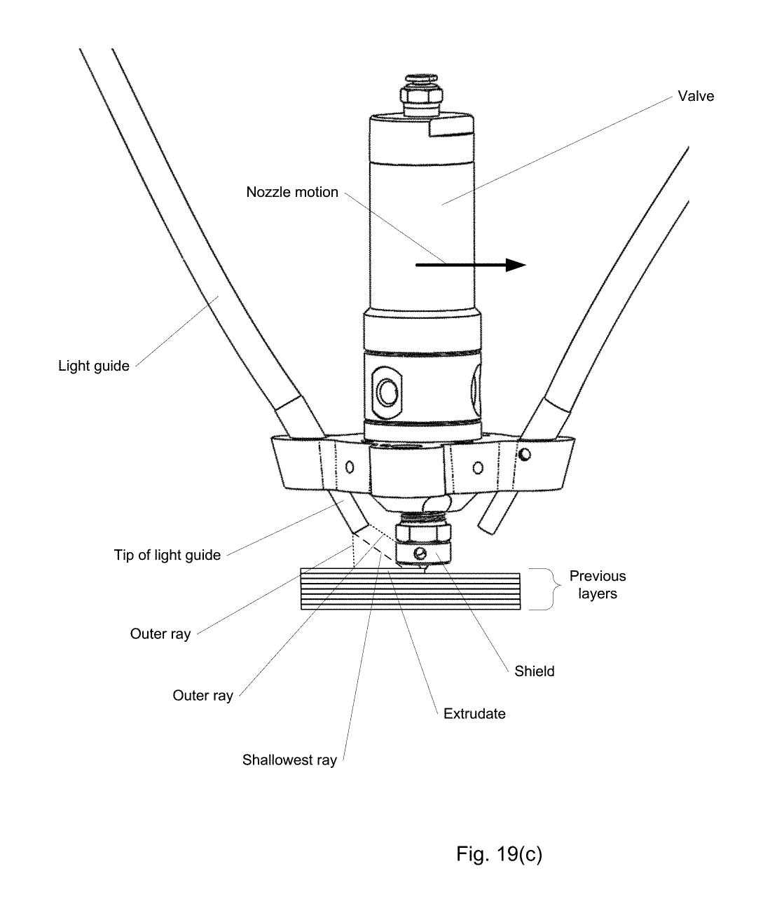

FIGS. 19(a)-(c) depict the distal end of a fluid delivery system (e.g., the printhead) used in some embodiments. The valve of FIG. 18 is depicted, equipped with an extrusion nozzle at its lower extremity, and in some embodiments a shield surrounding the nozzle. In the case of curing radiation (e.g., UV) which must be delivered to the extruded material from a remote source (a UV lamp), one or more light guides may be provided. In such cases, a light guide support may be mounted to the valve body to position and direct the output from the light guide. In some embodiments, LEDs used in lieu of remote UV sources with light guides can similarly be supported. In the figure, a support with capacity for up to four light guides 90° apart is shown. The function of the shield is to prevent curing radiation from curing the material immediately adjacent to the nozzle, which can clog the nozzle and/or bond the material to the nozzle. As depicted in FIG. 19(c), light is emitted from the tip of the light guide, in a shape bounded by the outer rays shown. The shield has a diameter (though it need not be cylindrical as shown; other shield/baffle shapes may be used to control direct and indirect (reflected or scattered) curing radiation) and a vertical position so as to block any light rays (including the shallowest ray shown) from reaching material within a desired radius of the nozzle. The lower surface of the shield is placed high enough that it does not make contact with the extruded material, though in some embodiments this may be desirable (e.g., if the shield also serves to thermally cure the material as in FIG. 12(d), or to smooth it). As shown, two light guides are provided. In this configuration, the curing of fill is according to the approach (#3) described above.

In some embodiments, a reflective chamber can be provided surrounding the nozzle. For example, an internally-polished aluminum cylinder, having a hole through which a light guide, LED, laser beam, or other radiation source can enter, allows light to bounce multiple times within the chamber and ultimately reach the extrudate located at the chamber bottom, forming a potentially uniform and well-defined spot that matches the cylinder inside diameter.

Incident radiation, intended to cure material after extrusion from the nozzle, can also cure material within the nozzle, clogging it and preventing extrusion. While the shield described above can be very beneficial, it may not be sufficient due to scattering and specular reflections of curing radiation from various materials and surfaces. Other methods used in some embodiments include incorporating an absorbing agent (e.g., carbon black) in the material that is appropriate given the wavelength(s) used for curing (e.g., 280-450 nm for UV-cured materials), such that incident light (reflected up into the nozzle) cannot penetrate too far. For example, for UV Electro 225-1, 0.05-1.00 weight percent (e.g., 0.15 weight percent) of carbon black, thoroughly mixed with the LSR (e.g., using a Speedmixer (Flacktek, Inc., Landrum, S.C.)), then filtered using a 40 μm nominal sintered depth filter to remove agglomerates) has been found to be effective in reducing unintended curing. If an excessive amount of absorbing agent is used, it can be difficult to cure the extruded material, especially for thicker layers. Other methods include use of a platform (a.k.a. a bed) which can absorb the curing radiation rather than reflect or scatter it (e.g., a UV-absorbing acrylic, glass coated with flat black paint (free of chemicals such as sulfur that may inhibit curing), or a material coated with an anti-reflection coating that is functional in the wavelength range of interest. Use of support materials which absorb the curing radiation (rather than reflect or scatter it) can also be beneficial.

Dielectric materials such as uncured silicone elastomer which are forced to flow through channels, tubes, nozzles, and other fluid conduits can become electrostatically charged through tribocharging. Moreover, material which is subject to ultraviolet radiation can become charged. When material is thus charged, electrostatic forces may affect the extrusion of material and interfere with precise placement (e.g., repulsive forces may displace an extrudate from its correct position). Methods of preventing electrostatic charging or dissipating charges which accumulate include 1) selection of grounded metallic—versus dielectric—materials for at least some (e.g., especially the furthest downstream) fluid conduits; 2) addition of conductive additives (e.g., carbon black, carbon nanotubes, graphene, or graphene oxide) to the material (for example, 0.05-1.00 weight percent (e.g., 0.15 weight percent) carbon black greatly assists in reducing charging); 3) use of a static control system (e.g., one which discharges ions such as the Easy static neutralizing system (Simco-Ion, Hatfield, Pa.).

Printhead nozzles can be prone to accumulate extruded materials such as silicones, especially near their tips. Accumulation on the nozzle can cause printing problems and is preferably kept to a minimum. Methods of reducing accumulation useful in some embodiments include 1) fabricating nozzles from (or coating them with) PTFE, polypropylene, polyethylene, high density polyethylene, ultra high molecular weight polyethylene, acetal, ceramic, the AMC148-18 coating (Advanced Materials Components Express, Bellefonte Pa.), or other materials which are difficult to wet; 2) printing more quickly, which tends to tear accumulation off the tip; 3) use of a nozzle having a conical or pyramidal (e.g., hexagonal or square pyramid) external shape with its surface(s) at a large angle to the horizontal; and 4) active nozzle cleaning, the last of which can be done frequently and as preventative maintenance in an automated manner (e.g., every layer or two).

In an AM system in which the printhead is raised as layers accumulate while the part platform remains at the same height, an active nozzle cleaner may be implemented using a wiping device (e.g., brush, pad, cloth, absorber, vacuum, etc.) which is extended horizontally, for example, from a position above the tallest part the system can build. This can be done as needed and after the printhead nozzle has been raised above the wiping device, after which the device can be retracted and the printhead lowered to continue. In a system in which the nozzle height is constant and the platform descends, the printhead can merely move (e.g., using X/Y stages) to a position where it can be wiped (e.g., by a fixed wiper, with the wiping motion, if any, provided by the stages themselves). In some embodiments, the wiper can be wet before use or during use by a chemical that tends to dissolve or more easily remove the accumulated material, or can be heated or cooled, or can incorporate motion of its own (e.g., rotation to polish the nozzle surface).

Bath-Based Processes

As one alternative to “extrude and cure” approaches to thermoset AM described above, AM of thermoset materials such as silicone may be performed in some embodiments using a process similar to stereolithography (U.S. Pat. No. 4,575,330) in which the material to be cured is in a vat, but is cured thermally instead of by exposure to light (e.g., UV) energy, as in standard stereolithography. For example, in lieu of a UV laser, a laser (e.g., carbon dioxide, Nd: YAG, fiber) providing thermal energy at a suitable wavelength can be used to cure the material. Alternatively, thermal energy from an incoherent infrared source (e.g., quart halogen lamp) may be delivered to the liquid surface using suitable focusing optics, an optical fiber, etc.

As another alternative suitable for two-component thermoset materials, in some embodiments one component may be deposited within another as in the Fripp application number PCT1GB2014/053190 cited above, but with certain improvements to address problems with the disclosed invention. Specifically, mixing of the two components can be greatly enhanced, providing better mixing and a faster reaction, by spinning the nozzle tip or the entire nozzle about its axis so as to locally agitate and mix the two components. Rotation may also be used to alter the cured width of the material as the needle moves through the liquid in the bath. To reduce dependence on supports, material buoyancy can be better regulated by controlling the temperature of the bath and/or by localized heating or cooling of the nozzle.

Control System

The control of the apparatus and the implementation of the methods and steps described herein may be achieved using hardware, software, or any combination thereof, together forming a control system. The term “hardware” may refer to either one or more general or special purpose computers; microcontrollers; microprocessors; embedded controllers; or other types of processor, any of which may be provided with a memory capability such as static or dynamic RAM (random access memory); non-volatile memory such as ROM (read only memory); EPROM (erasable programmable read only memory), or flash memory; magnetic memory such as a hard drive; optical storage media such as CD (compact disc) or DVD (digital versatile disc); etc. The term may also refer to a PAL (programmable array logic) device, an ASIC (application specific integrated circuit), an FPGA (field programmable gate array), or to any device capable of processing and manipulating electronic signals.

The term “software” may refer to a program held in memory, loaded from a mass storage device, firmware, and so forth. The program may be created using a programming language such as C, C#, C++, Java, or any other programming language, including structured, procedural, and object oriented programming languages; assembly language; hardware description language; and machine language, some of which may be compiled or interpreted and use in conjunction with said hardware.

The control system may serve to load files, perform calculations, output files, control actuators such as motors, voice coils, solenoids, fans, and heaters, and acquire data from sensors, to automate or semi-automate apparatus which can implement the methods and steps described herein. Each method described herein, including any sequential steps that may be taken for the method's implementation and any modification of the behavior of the apparatus or control system as a result of human or sensor input, as well as combinations of such methods, may be implemented and performed by the control system, executing a program, or code, embodied in the control system. In some embodiments, multiple control systems may be employed, and portions of the functionality of the control system may be distributed across multiple pieces of hardware and/or software, or combined into a single piece of hardware running a single piece of software.

General

It will be understood that particular embodiments described herein are shown by way of illustration and not as limitations of the disclosed subject matter. The principal features of the disclosed subject matter can be employed in various embodiments without departing from the scope of the disclosure. Those skilled in the art will recognize, or be able to ascertain using no more than routine experimentation, numerous equivalents to the specific procedures described herein. Such equivalents are considered to be within the scope of the disclosed subject matter and are covered by the claims.

All publications and patent applications mentioned in the specification are indicative of the level of skill of those skilled in the art to which the disclosed subject matter pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context. In certain embodiments, the present disclosure may also include methods and compositions in which the transition phrase “consisting essentially of” or “consisting of” may also be used.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the compositions and/or methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and/or methods and in the steps or in the sequence of steps of the method described herein without departing from the concept, spirit and scope of the disclosed subject matter. All such similar substitutes and modifications apparent to those skilled in the art are deemed to be within the spirit, scope and concept of the disclosed subject matter as defined by the appended claims.

Applications:

Embodiments of the disclosed subject matter may enable or facilitate a wide range of applications including the following:

Rapid, cost-effective custom fabrication of products such as patient-customized long-term implants, prosthetics, and orthotics made from strong, affordable, off-the-shelf materials such as pure, medical-grade silicones. Implants and prosthetics may be used for soft tissue replacement, for example. Applications include ophthalmic, vocal fold, finger joint, and reconstructive implants (e.g., leak-free, lightweight breast implants for mastectomy patients), hydrocephalus shunts, heart valves, intraocular lenses, as well as nose, ear, and finger prosthetics (e.g., for accident victims or to correct anatomical deformities). The ability to vary elastic modulus to provide the right stiffness in the right locations is useful for achieving life-like behavior, especially since many living structures have variable (e.g., graded) material properties that help them function (e.g., hard where stiffness is required, soft where toughness is needed). Anatomically-specific wound healing dressings and devices, and patient-customized dental bleaching trays and bite guards, e.g., printed based on intra oral scan data, are among other applications.

Elastomeric products can also be made from single and multiple materials such as patient-customized orthotics and goggles; and face masks, and respirators for divers, fighter pilots, CPAP (continuous positive airway pressure) patients, and people working with hazardous materials. Earplugs, earbuds, and hearing aid shells that are individually customized are among other objects that may be made.

There is a need for anatomically accurate, realistic models of human tissue and organs for purposes of medical training, device development, and pre-surgical planning, e.g., as an affordable and available alternative to cadaveric tissue. The disclosed subject matter can be used to produce models simulating the elastic modulus (and ideally, color) of actual tissue, e.g., based on CT, MRI, or ultrasound scans of individual patients.

Catheters used in interventional medical procedures typically vary in hardness from proximal to distal end, and must be fabricated through a laborious process of separately extruding and joining multiple sections of tubing. With the process and apparatus described herein, these could be produced monolithically, and if desired be tailored to a patient's unique anatomy.

The ability to precisely mix and print multiple fluids can benefit bioprinting of tissue and tissue scaffolds, for example, polymer scaffolds having built-in chemical gradients that promote/direct tissue growth.

Implants (e.g., silicone) or other medical devices which elute drugs in a controlled fashion can be fabricated using the methods and apparatus described herein. Drugs that can be delivered using silicone (polydimethyl siloxane), for example, include antiviral compounds, antibiotics, antidepressants, antiangiogenics, anxiolytics, vitamins, antifungals, antiviral compounds, and opioid and nonopioid analgesics. For example, age-related macular degeneration (AMD) can be treated using a drug-eluting episcleral device (e.g., approximately disk-like in shape) made using medical-grade silicone, in which the drug (e.g., an anti-angiogenic) is mixed with silicone before it is cured. The ability to fabricate an implant using AM by itself allows the customization of geometry to the patient: matching the curvature of the device to the curvature of the eyeball to achieve intimate contact and better resistance to migration, adjusting the size and thickness to anatomical constraints and to the volume and type of drug to be delivered, providing porosity to encourage integration with tissue, etc. Furthermore, AM enables complex geometry in the device, such as fixation and anchoring structures including microscale suction cups and rings and micro-Velcro®-like structures which achieve improved adhesion to eye tissue; internal cavities to contain drug in liquid, solid, or gel form (e.g., serpentine channels, reservoirs); and so forth.

Moreover, by also being able to modulate the composition of the device locally, additional functionality can be provided. For example, by adjusting drug concentration on a voxel-by-voxel basis, release rate and directionality can be controlled, and multiple drugs can be incorporated in the same device, each with its own distribution profile, release kinetics, and directionality. Portions of the device which contain drugs may be given customized geometries which influence the rate and directionality of drug release. Some portions of the device can be made to contain and elute drug, while others can be passive, serving as diffusion barriers that control the timing and directionality of drug release. For example, the surface of the device facing away from the sclera, as well as the edges of the device, can be fabricated with one or more diffusion barriers. The permeability of the device to the drug may be altered by formulation (e.g., mixing different grades of silicone, mixing silicone with other materials such as poly(methyl methacrylate) or with fillers, or introducing gas bubbles into the silicone). Thus, some voxels may be formed with a high permeability to maximize drug elution through them, while other voxels (e.g., those intended as diffusion barriers) may be formed with a low-permeability material. Mixing of grades or materials may also be used to vary elastic modulus locally, helping the device better conform to tissue, etc. In general, simply being able to encapsulate one material with another can enable a number of drug delivery devices.

Scleral implants may require a smooth, concave compound curvature on the side in contact with the sclera. It is normally challenging due to layer stairsteps to additively manufacture a curved object with a complex curvature (e.g., hemispherical) having a smooth surface. However, the device can be fabricated in a flat configuration, but with residual stresses built in which are tailored to distort it into the required shape after fabrication is complete. Alternatively, the device can be fabricated using curved layers; e.g., a hemispherical surface fabricated using a 3-D spiral extrusion toolpath in which the nozzle can move simultaneously along the X, Y, and Z axes as it extrudes material. Such approaches may also be adapted to create optical elements such as intraocular lenses and contact lenses.

Drug-delivery devices may be made from materials which allow post-adjustment after implantation. For example, magnetic materials incorporated into a device using methods and apparatus such as those described herein can allow for the rate and/or direction of drug elution to be adjusted from a distance using magnetic forces which act on the implant. Drug delivery devices may also incorporate sensors to indicate their status or report on physiological conditions.

Capabilities and approaches described herein (e.g., fabricating drug delivery implants for the eye or for other medical indications) and enabled by the methods and apparatus of the disclosed subject matter may also be applied to other medical devices including instruments and implants.

The micro-blending ability provided by the methods and apparatus disclosed herein can also be extended to making composite materials such as those which comprise a continuous matrix (e.g., polymer) with a filler (e.g., a metal, ceramic, or polymer powder or microscale fiber). By pre-blending liquid binders with ceramic or metal powders, FDM has been used to print and then thermally process structures to create functional parts [Vaidyanathan et al., 2009]. Likewise, with particulate-filled polymers it is possible to fabricate structures which include thermally and electrically conductive, radiopaque, and even magnetic regions (e.g., using NdFeB powders [Xiao, 2000] such as those sold by Magnequench (Science Park II, Singapore), or strontium ferrite powders such as those made by Hoosier Magnetics (Ogdensburg, N.Y.)), or particles or fibers which enhance mechanical properties. Appropriate modification of the micro-blending process described herein also allows locally varying the filler concentration to yield parts with abrupt interfaces between volumes with disparate properties or functionally graded parts. Applications for graded parts include orthopedic implants, sporting goods, and advanced armor.

Soft robotics—a rapidly-emerging field—commonly use hydraulic or pneumatic actuators. In general, hydraulic devices including robots that are moved hydraulically may be produced, including devices in which hydraulic fluid is printed in place. For example, through the use of thermoset elastomers such as silicone, structures which expand when filled with fluid, or which contract when fluid is pumped out (e.g., when vacuum is applied) can be produced. Such structures may include chambers which are designed to print without the need for support material within (e.g., with the “roof” of each chamber at an angle greater than 45° to the horizontal, allowing the roof to be self-supporting). Chambers can in some embodiments include individual valves and/or pumps, and structures can be built in which the geometry and/or composition is modulated to enable non-linear behavior (e.g., in compression, tension, or torsion) For example, a cube can be printed which is initially stiff when compressed near one surface, but then suddenly buckles once a threshold pressure is applied.

The ability to print robot components with locally-tailored elastic modulus facilitates actuation, e.g., using a relatively soft elastomer for an actuator based on an expanding bladder, and an elastomer or other material with relatively high modulus of elasticity as a rigid “skeleton” element or fluidic conduit. Similarly, relatively stiff materials used for supports may be fully encapsulated by soft material especially if soluble, and thus are left intact during the support removal process, serving as internal skeletons for the fabricated object. Printing both solid elastomer (e.g., silicone) and a liquid with a hydraulic force-transmitting function is possible [MacCurdy et al., 2016] using methods disclosed herein, and with far softer materials. A key requirement is that the processing of the solid and liquid is compatible. For example, if the solid is a silicone elastomer, the liquid can be a silicone oil, or one part (e.g. the base) of a two-part silicone elastomer formulation, that is dispensed into the appropriate channels, chambers, and reservoirs, where it can also serve as a support material during fabrication. Other materials such as water and oil may also be used.

Clothing and accessories such as wet suits, shoes, and jewelry; wearable electronic devices, and microfluidic devices (e.g., for lab-on-a-chip or chemical reactors), may also be made.

Tactile displays and haptic feedback devices may be produced.

Monolithically-fabricated fluidic devices such as pumps and valves may be produced.

Objects with spatially-varied properties (such as elastic modulus) modulus) may be produced which exhibit metamaterial properties such as diverting or dissipating impact (e.g., for a protective helmet application), modifying the propagation of energy (e.g., light, sound, vibration, heat), etc.

Vibration isolation devices, including those which behave anisotropically, may be produced.

Testable prototypes of rubber products that will be molded in production such as seals, gaskets, valves, electrical connectors, and O-rings can be produced.

Colored models and prototypes may be produced for use in product development, architecture, and medical/scientific data visualization, topographical maps, etc. Moreover, the methods and apparatus disclosed herein when combined coupled with 3-D scanners known to the art may be used for full-color and/or multi-material 3-D facsimile systems.

Tooling for molding (e.g., injection molding, blow molding, casting) of thermoplastic materials such as ABS, thermoplastic elastomer, wax, and low melting point alloys, and thermoset materials such as urethanes may be rapidly fabricated using methods and apparatus described herein. Cooking tools, bakeware, and molds (e.g., made from silicone elastomer) may also be produced.

Optical elements such as standard lenses (e.g., intra-ocular and contact lenses for medical use) or gradient-index lenses can be manufactured (the latter using multiple materials with different refractive indices). Surfaces with “stair step” or other artifacts can be smoothed by reflow (e.g., using surface tension or contact with a smooth mold).

Multi-material and/or full-color prototypes and end-use products can be produced from desirable engineering polymers such as thermoplastics and thermosets. For example, more realistic and useful prototypes can be made of products which in full-scale manufacturing will be made from multiple parts, each with its own material properties, or made using two-shot molding or similar methods. Benefits of producing products using fewer parts include cost reduction due to relaxed tolerances, reduced assembly labor, and reduced inventory costs.

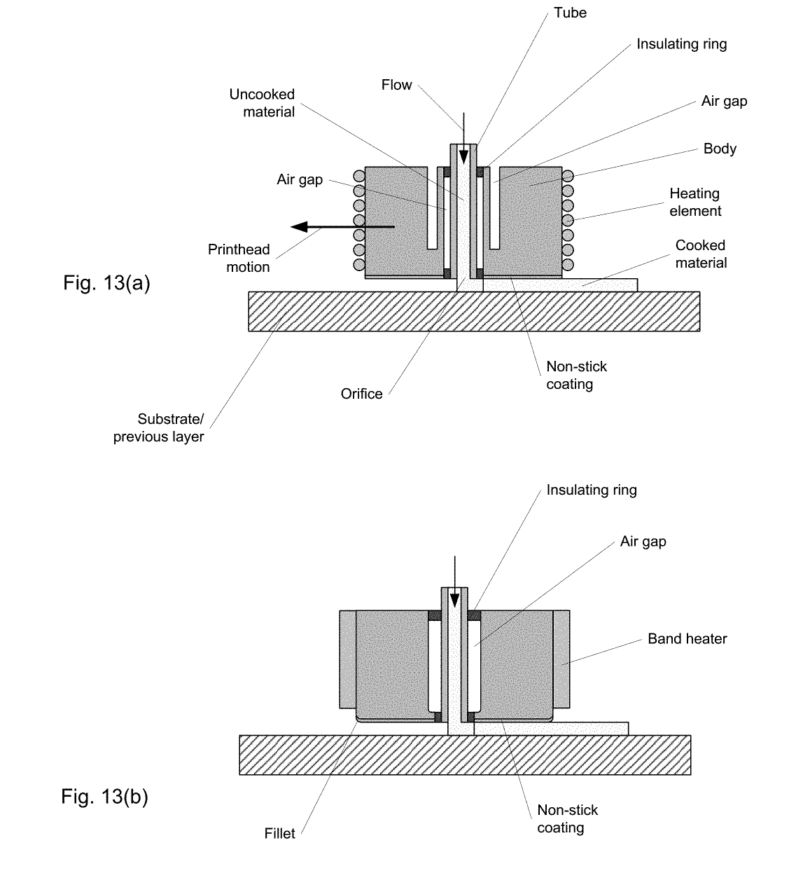

The apparatus and methods described herein are applicable to the preparation of foods. For example, to produce foods using AM one may wish to deposit different ingredients and mixtures thereof at different spatial locations, achieving abrupt transitions between them, or produce gradients in flavor, smell, texture, color, etc. Moreover, certain foods can be transformed by heating (e.g., by denaturing proteins). For example, the apparatus and methods described herein can be used to 3-D print a structure made from egg or an egg-containing mixture such as a batter by extruding the egg or mixture and subjecting it to heat as it extrudes. FIG. 13 depicts a printhead for an AM system which can be used to simultaneously deposit and cook a liquid, paste, or gel (or in some embodiments deposit and thermally cure a liquid, paste, or gel, etc.), and with some similarities to the printhead and heated ring of FIG. 12(d). Such an AM system can fabricate, for example, various foods which contain ingredients which solidify or rigidify upon exposure to heat such as those containing proteins which denature (e.g., egg, animal muscle). Thus omelets, baked goods, and meats, for example may be cooked with complex 3-D shapes. Two exemplary variations of the printhead are shown in FIGS. 13(a) and (b); a suitable printhead may incorporate elements from one or both of these, and/or other elements. In both variations, uncooked material enters (e.g., via gravity, pressurized by a pump) through a tube that is surrounded by an insulator (e.g., an air (or vacuum) gap as shown, a thermally stable insulating material (e.g., PTFE), aerogel, etc.). The insulator serves to isolate the material from the heated body of the printhead. If air or vacuum is used, insulating rings are provided to support the tube within the body of the printhead. The body of the printhead is preferably of a highly thermally conductive material such as aluminum or copper and may be heated by a heating element such as a cartridge heater (not shown), a heating cord wrapped around it (FIG. 13(a)) or a band heater surrounding it (FIG. 13(b)). The underside of the body, serving the function of the heated ring in FIG. 12(d), may be coated with a non-stick coating on its underside, such as PTFE and/or a cooking oil, to minimize adhesion to the body. In some embodiments, the liquid or gel being extruded may contain non-stick additives such as cooking oil. The bottom edge of the body may be filleted as in FIG. 13(b) to help break any adhesion of the cooked material. As uncooked material reaches the bottom edge of the tube and extrudes out through the orifice of the tube (which may have a different (e.g., smaller) diameter than the tube inside diameter), the printhead moves forward, causing extruded liquid to come into contact with the lower surface of the printhead body. Since the printhead preferably moves with a reasonable speed (e.g., 10-100 mm/sec), the temperature of the lower surface may be made much greater than that of typical cooking surface such as a frying pan or griddle, minimizing the available cooking time.

The ability to fabricate anisotropic objects by selectively incorporating multiple materials can be used to compensate for anisotropic properties exhibited by objects fabricated from a single material, making the object more isotropic. Furthermore, the ability to fabricate inhomogeneous objects by selectively incorporating multiple materials can be used to compensate for inhomogeneous properties exhibited by objects fabricated from a single material, making the object more homogeneous.

Objects fabricated according to the methods and apparatus described herein may be designed to behave in complex ways (e.g., deform into certain shapes when stressed).

By integrating the disclosed subject matter with the subject matter described in nonprovisional U.S. patent application Ser. Nos. 14/213,908 and 14/213,136 (which describe Fiber Encapsulation Additive Manufacturing (FEAM), in which a fiber and matrix material are simultaneously deposited in a 3-D printing process), the applicability of the latter applications can be extended. For example, using thermoset materials according to the disclosed subject matter it would be possible to additively manufacture actuators that can withstand higher currents without softening; print circuit boards (or 3-D versions thereof) which can better tolerate the heat of soldering; provide junctions between wire with solders having higher melting points; fabricate pacemaker and implanted cardioverter defibrillator leads and neurostimulation electrodes (e.g., for deep brain stimulation, vagus nerve stimulation, peripheral motor nerve stimulation, and cochlear implants) having many channels—now very challenging to make—from long-term implantable materials such as silicone and Pt—Ir wire; produce soft robotic components in which the local hardness is varied to achieve more complex motions, create bone-like rigid elements, etc.; and create composite materials using thermoset resins along with glass fiber, carbon fiber, or Kevlar as embedded reinforcing fibers. In the case of deep brain stimulation probes or other electrodes requiring a relatively stiff configuration during insertion/implantation, suitably-designed devices may be temporarily stiffened hydraulically (e.g., if they contain channels or interconnected pores), by inclusion of a softenable stiffener (e.g., an encapsulated material which softens at body temperature, such as a wax or shape memory polymer), a sacrificial stiffener (e.g., a wire which can be withdrawn or etched out chemically or electrochemically, etc.). An AM system which enables FEAM and also enables curing of extruded liquid, paste, or gel may in some embodiments locate the curing radiation source 180° opposite the capillary through which the fiber is fed.

Heaters can be fabricated with thermosets and FEAM custom shapes, distribution of heating elements, wattages, etc.—including those difficult to manufacture conventionally—by combining high temperature-stable materials such as silicone or polyimide with resistive, Joule-heated wires such as nickel-chromium. Or, if wires are thinner and longer than is needed, a less resistive material as substantially pure nickel can be used. Wire can be continuous in some embodiments (in which case it doesn't need to be cut by the printer), or it can be discontinuous, with inter-layer junctions spanning multiple layers. Intra-layer junctions may also be used as needed. Heaters can incorporate built-in thermocouples (e.g., two dissimilar wires with a suitable junction between them) or other temperature sensors. The use of encapsulated heating wire also allows for thermal curing of wire-containing extrudates by running current through the wires (e.g., contacting the wire in two locations while printing). Resistive thermal curing can in some embodiments be used on its own, while in other embodiments it can serve as an assist to curing. For example, wire can act as a heat sink making thermal curing more difficult, and can also shadow the material to be cured; thus heating the wire can help compensate for such effects.

For robotic and other applications requiring a source of energy, it is also possible to burn hydrocarbon fuels within a device fabricated using methods disclosed herein. For example, butane can be burned at low temperature (tolerable to silicone elastomer) using a suitable catalyst such as a platinum-group metal; the catalyst may be introduced into the fabricated structure as a foil, a powder, a wire, etc. If a wire, the wire may be introduced using FEAM. The burning fuel generates heat which can be used to expand gasses that can directly provide, with suitable actuators, propulsion or manipulation capabilities. Alternatively, the heat may be converted into electrical energy using methods such as thermoelectric converters (suitable materials such as bismuth telluride may be inserted into the structure during fabrication), or through thermomechanical energy conversion methods such as reciprocating and rotary engines.

Ramifications:

In some embodiments, objects may be built from only a single thermoset material, using thermoset curing methods and apparatus described herein. In some embodiments, objects may be built from multiple materials which are deposited individually without inter-mixing.

In some embodiments, objects may be built using an approach analogous to halftone printing in which multiple materials aren't mixed. Rather, they are deposited in small volumes and these volumes (e.g., of two or three different materials) are interleaved in one, two, or three dimensions to form a material having an average, integrated behavior that is determined by the materials that comprise it. The volumes may be as small as single voxels (with each voxel having the minimum possible volume of deposited material) or may include cluster of voxels. For example, suppose two compatible and mutually adherent materials M and N with different elastic moduli EM and EN, respectively, are deposited as single cubic voxels measuring 500 μm on a side, interleaved in X, Y, and Z to form a 3-D checkerboard-like pattern. The average modulus of the material EA would then be halfway between the values of EM and EN. If on the other hand, the material comprised more voxels of material M than of material N (e.g., material M voxels in a cluster) EA would be closer to EM than to EN.

The use of multiple materials and/or colors readily allows objects to incorporate many design features such as labels, logos, textures, and bitmap images.

Not all polymers can be blended and not all can adhere well to others, though through the use of tie resins such as ADMER™ (Mitsui Chemicals America, Inc., Rye Brook, N.Y.) or TYMAX™ (Westlake Chemical Corporation, Houston, Tex.) otherwise-non-adherent resins may be combined. Adhesion promoters (e.g., silane-based) can be used when needed, and may be useful for improving adhesion between fabricated parts and supports in some embodiments.

The methods and apparatus described herein may be applied to fabrication of objects using ceramics or metals (similar to ceramic and metal injection molding) as well as polymers. For example, green ceramic structures comprising ceramic powder(s) and binder(s) in which the composition is spatially modulated can be fabricated; these may then be fired if needed to obtain the final properties. Piezoelectric devices such as ultrasonic transducers, electronic substrates similar to LTCC (low temperature co-fired ceramic) or HTCC (high temperature co-fired ceramic) substrates with built-in metallization and passive components, magnets, and orthopedic implants are among possible applications. Metal parts comprising multiple types of metal particles and/or multiple binders may be produced, producing for example hard metal surfaces for wear resistance with soft interior volumes for impact resistance. Molten metals may also be mixed and variably alloyed using methods and apparatus similar to those described here. In general, heterogeneous objects can be produced in which the general type of material (e.g., ceramic, metal, thermoplastic polymer, thermoset polymer, living cell) as well as the particular properties of material (e.g., durometer, color) is spatially varied in abrupt or continuous fashion.

### REFERENCES

D. Ahmed, X. Mao, J. Shi, B. Juluri, and T. Huang (2009) A millisecond micromixer via single-bubble-based acoustic streaming. Lab Chip, 9, 2738-2741.
I. Barker, M. Ablett, H. Gilbert, S. Leigh, J. Covington, J. Hoyland, S. Richardson, and A. Dove (2013) A microstereolithography resin based on thiol-ene chemistry: towards biocompatible 3D extracellular constructs for tissue engineering, Biomat. Sci. 18 December.
H. Boyer, A. Douglas, and N. Pettis (2014) Build material switching, U.S. patent application #2014/0034214.
L. Capretto, W. Cheng, M. Hill, and X. Zhang (2011) Micromixing within microfluidic devices. Top. Curr. Chem., 304, 27-68.
S. Clarson, S. Fitzgerald, M. Own, and S. Smith, eds. (2000) Silicones and Silicone-Modified Materials American Chemical Society, Washington, D.C.
F. Dickey, editor and contributing author (2014) Laser Beam Shaping: Theory and Techniques, Second Edition, CRC Press, Taylor and Francis Group, Boca Raton, N.Y.
I. Grida and J. Evans (2003) Extrusion freeforming of ceramics through fine nozzles. Journal of the European Ceramic Society, 23, 629-635.
O. Hall, C. Hills, and A. Gilbert (2007) Slow flow between concentric cones. Q. Jl. Mech. Appl. Math, 60, 27-48.
O. Hall, C. Hills, and A. Gilbert (2009) Nonaxisymmetric stokes flow between concentric cones. Q. Jl. Mech. Appl. Math, 62 132-148.
J. Hardin, T. Ober, A. Valentine, and J. Lewis (2015) Microfluidic Printheads for Multimaterial 3D Printing of Viscoelastic Inks [0001] Advanced Materials 27: 3279-3284.C. Hoyle, T. Lee, and T. Roper (2004) Thiol-enes: Chemistry of the past with promise for the future, J. Polym. Sci., Pt. A Polym. Chem. 42, 5301-5338.
C. Hoyle and C. Bowman (2010), Thiol-Ene Click Chemistry, Angew. Chem. Int. Ed. Engl. 2010, 49, 1540-1573.
T.-W. Huang, J.-H. Tsai, C.-P. Cherng, and J.-K. Chen (1994) Silicone rubber curing by high intensity infrared radiation, AIP Conference, Kansas City, Mo., American Institute of Physics Conf. Proc. 316, 305.
A. Jennings and D. Son (2013) Multifunctional thiols from the highly selective reaction of mercaptoalcohols with chlorosilanes, Chem. Commun. 49, 3467-3469.
J. Lewis, J. Smay, J. Stuecker, and J. Cesarano III (2006) Direct Ink Writing of Three-Dimensional Ceramic Structures, J. Am. Ceram. Soc., 89, 3599-3609.
C.-H. Lin, C.-H. Tsai, and L.-M. Fu (2005) A rapid three-dimensional vortex micromixer utilizing self-rotation effects under low Reynolds number conditions. J. Micromech. Microeng., 15, 935-943.
A. Li, A. Thornton, B. Deuser, J. Watts, M. Leu, G. Hilmas, and R. Landers (2012) Freeze-form extrusion fabrication of functionally graded material composites using zirconium carbide and tungsten. Solid Freeform Fabrication Symposium Proceedings, The University of Texas Press, Austin, 467-479.
M. Long, M. Sprague, A. Grimes, B. Rich, and M. Khine (2009) A simple three-dimensional vortex micromixer. Appl. Phys. Lett., 94, 133501 (3 pp.).
R. MacCurdy, R. Katzschmann, Y. Kim, and D. Rus (2016). Printable Hydraulics: A Method for Fabricating Robots by 3D Co-Printing Solids and Liquids. 2016 IEEE International Conference on Robotics and Automation (ICRA).
P. Mariner, J. Wudel, D. Miller, E. Genova, S. Streubel, and K. Anseth (2012). Synthetic hydrogel scaffold is an effective vehicle for delivery of INFUSE (rhBMP2) to critical-sized calvaria bone defects in rats. J Orthop Res. 2013 March; 31(3), 401-406.
O. McNair, B. Sparks, A. Janisse, D. Brent, D. Patton, and D. Savin (2013) Highly Tunable Thiol-Ene Networks via Dual Thiol Addition, Macromolecules 46, 5614-5621.
T. McNulty, F. Mohammadi, A. Bandyopadhyay, D. Shanefield, S. Danforth, and A. Safari, (1998) Development of a binder formulation for fused deposition of ceramics, Rapid Prototyping Journal, 4, 144-150.
N.-T. Nguyen and Z. Wu (2005) Micromixers—a review. J. Micromech. Microeng., 15, R1-R16.
T. Ober, D. Foresti, and J. Lewis (2015) Active mixing of complex fluids at the microscale. PNAS 2015 112 (40) 12293-12298.
N. Oxman (2011, #1) Methods and apparatus for variable property rapid prototyping, U.S. Patent Application #2011/0079936 A1.
N. Oxman (2011, #2) Variable property rapid prototyping. Virtual and Physical Prototyping, 6:1, 3-31.
C. Pax (2014) Color switching for three-dimensional printing, U.S. Patent Application #2014/0070461.
D. Periard, E. Malone, and H. Lipson (2007) Printing Embedded Circuits, Solid Freeform Fabrication Symposium Proceedings, The University of Texas Press, Austin, 503-512.
B. Reilly and E. Brunet (2012) Accelerating Cure Times of Medical Silicone Adhesives with Infrared Radiation, Medical Design Briefs, online http://www.medicaldesignbriefs.com/component/content/article/13923.
M. Shofner, K. Lozano, F. Rodriguez-Macias, and E. Barrera (2003) Nanofiber-reinforced polymers prepared by Fused Deposition Modeling. J. Applied Polymer Science, Vol. 89, 3081-3090.
R. Skubic, J. Comb, J. Grudem, W. Swanson, J. Batchelder, and S. Brose (2011) Viscosity pump for extrusion-based deposition systems, U.S. Pat. No. 7,891,964, February 22.
R. Vaidyanathan, J. Lombardi, J. Walish., S. Kasichainula, P. Calvert, and K. Cooper (1999) Extrusion Freeform Fabrication of Functional Ceramic Prototypes. Solid Freeform Fabrication Symposium Proceedings, The University of Texas Press, Austin. 327-334
J. Xiao, J. Otaigbe, and D. Jiles (2000) Modeling of magnetic properties of polymer bonded Nd—Fe—B magnets with surface modifications. J. Magnetism and Magnetic Materials 218, 60-66.
C. Zhu and J. E. Smay (2011) Thixotropic rheology of concentrated alumina colloidal gels for solid freeform fabrication. J. Rheol., 55, p. 655.

1. An additive manufacturing method for fabricating objects from a silicone elastomer, the method comprising:
extruding a silicone elastomer to form at least a portion of a layer of a fabricated part;
curing the silicone elastomer using a source of energy;
melting and extruding a removable support material to form a portion of a support structure for the fabricated part;
removing the support structure after at least several layers comprising silicone elastomer have been formed.

2. The method of claim 1 wherein the support material comprises poly(ethylene glycol) or poly(ethylene oxide).

3. The method of claim 2 wherein the poly(ethylene glycol) or poly(ethylene oxide) have molecular weights (MW) between 5,000 and 1,000,000.

4. An additive manufacturing method for fabricating objects from a solidifiable material, the method comprising:
depositing a thermoset material having a form selected from the group consisting of liquid, paste, or gel from a nozzle onto a substrate to form at least a portion of a layer of a fabricated part;
moving the nozzle relative to the substrate;
solidifying the deposited thermoset material using a source of energy;
wherein the source of energy is substantially directed at the material during the formation of the layer to expose it.

5. The method of claim 4 wherein the source of energy is directed at the material immediately upon deposition.

6. The method of claim 4 wherein the source of energy is directed at the material after a delay during which the material is allowed to flow.

7. The method of claim 4 wherein previously-deposited material is substantially unexposed to the energy.

8. The method of claim 4 wherein the source of energy is directed substantially tangent to the motion of the nozzle relative to the substrate as it deposits material.

9. The method of claim 8 wherein the source of energy rotates around the nozzle as it deposits material.

10. The method of claim 8 wherein the substrate is rotated beneath the nozzle.

11. The method of claim 4 wherein the thermoset material comprises an absorber of the radiation.

12. The method of claim 11 wherein the absorber is selected from the group consisting of carbon black or iron oxide.

13. The method of claim 4 wherein the thermoset material comprises a conductive material.

14. The method of claim 13 wherein the conductive material is selected from the group consisting of carbon black, carbon nanotubes, graphene, or graphene oxide,

15. The method of claim 4 wherein a shield is used to reduce exposure of the nozzle to the source of radiation.

16. An additive manufacturing method for fabricating composite objects from a curable material and a continuous fiber, the method comprising:
depositing a curable material having a form selected from the group consisting of liquid, paste, or gel from a nozzle to form at least a portion of a layer of a fabricated part;
delivering a fiber into the curable material as it issues from the nozzle;
using a source of energy to cure the material immediately after it is deposited;
wherein the fiber is encapsulated within the cured material.
